(19) United States
(12) Patent Application Publication
(10) Pub. No.: US 2016/0080319 A1
(43) Pub. Date: Mar. 17, 2016

(54) SYSTEM TO IDENTIFY A COMPUTER ON A NETWORK

(71) Applicant: Robert STEELE, Venice, CA (US)

(72) Inventor: Robert STEELE, Venice, CA (US)

(21) Appl. No.: 14/945,551

(22) Filed: Nov. 19, 2015

Related U.S. Application Data
(63) Continuation-in-part of application No. 13/437,756, filed on Apr. 2, 2012.
Application No. 13/437,756 is a continuation-in-part of application No. 13/485,178, filed on May 31, 2012.
Application No. 13/485,178 is a continuation-in-part of application No. 13/594,596, filed on Aug. 24, 2012.
(60) Provisional application No. 61/470,541, filed on Apr. 1, 2011.
(60) Provisional application No. 61/491,415, filed on May 31, 2011.
(60) Provisional application No. 61/526,946, filed on Aug. 24, 2011.
(60) Provisional application No. 62/082,789, filed on Nov. 21, 2014.

(51) Int. Cl. H04L 29/12; H04L 29/08; H04L 12/741

(52) U.S. Cl. CPC H04L 61/2517; H04L 45/745; H04L 67/146; H04L 67/06; H04L 61/2007

(57) ABSTRACT

A system, a method, and a computer program for identifying a device on a network that participates in communication sessions, where the device may rotate its IP address between communication sessions. A plurality of unauthorized communication sessions that are carried out on different IP addresses are captured, stored, and analyzed to determine whether the same device was used during the communication sessions.

### CROSS-REFERENCE TO RELATED APPLICATIONS

This application claims priority and the benefit thereof from U.S. Provisional Patent Application No. 62/082,789, filed Nov. 21, 2014, titled “System to Verify User Download or Streaming of Multimedia Content,” the entirety of which is hereby incorporated herein by reference. This application is a continuation-in-part of U.S. patent application Ser. No. 13/437,756, filed Apr. 2, 2012, which is based on and claims priority to U.S. Provisional Patent Application No. 61/470,541, filed Apr. 1, 2011, and a continuation-in-part of U.S. patent application Ser. No. 13/485,178, filed on May 31, 2012, which is based on and claims priority to U.S. Provisional Patent Application No. 61/491,415, filed May 31, 2011, and a continuation-in-part of U.S. patent application Ser. No. 13/594,596, filed Aug. 24, 2012, which is based on U.S. Provisional Patent Application No. 61/526,946, filed Aug. 24, 2011, all of which are hereby incorporated herein by reference in their entireties.

### FIELD OF THE DISCLOSURE

The present disclosure relates to a system, a method, and a computer program for identifying a device on a network such as the Internet, regardless of whether a static or dynamic IP address is assigned to the device.

### BACKGROUND OF THE DISCLOSURE

Computers are generally identified on the Internet by an Internet Protocol (IP) address. The IP address typically includes a 32-bit number (e.g., IPv4) or a 128-bit number (IPv6). The IP address serves two primary functions. First, the IP address identifies the host or network interface. Second, the IP address identifies the location of a device on the Internet.

IP addresses are generally assigned to devices such as computers at the time of booting (known as a “dynamic IP address”), or permanently by fixed configuration of the device's hardware or software (known as a “static IP address”). Dynamic IP addresses are commonly assigned anew by a Dynamic Host Configuration Protocol (DHCP) server each time a device connects to a DHCP server network, such as, for example, a local area network (LAN), a broadband network, a wide area network (WAN), or the like. An Internet Service Provider (ISP) may, however, repeatedly assign the same IP address to the same computer device at each boot-up.

A static IP address on the other hand is permanently assigned to a particular device (e.g., a company or government computer, server, VPN server, or the like) and may be used to identify the device on a network. Static IP addresses are typically used for commercial applications, compared to dynamic IP addresses, which are more commonly used for residential applications.

Accordingly, when a device is connected to a network using a static IP address, it may be possible to repeatedly and consistently identify the particular device based on the IP address. However, when a device is connected to a network such as the Internet using a dynamic IP address, it can become extremely difficult, if not impossible to identify a particular device based on IP address alone, as the address is subject to change.

The disclosure provides a novel method, system, and computer program to identify a device such as a computer on a network such as the Internet, regardless of whether the IP address assigned to the device changes.

### SUMMARY OF THE DISCLOSURE

Accordingly, the present disclosure provides a system, a method, and a computer program that identify a device participating in a communication session on a network where an IP address assigned to the device is subject to change.

According to an aspect of the disclosure, the network system identifies a device participating in two or more communication sessions on the network where an IP address assigned to the device is subject to change, the network system comprising: a network interface that receives a data packet from the device corresponding to a communication session that includes a portion of a predetermined file; a packet parser that separates metadata from a header of the received data packet, the metadata comprising an IP address and a port number corresponding to the received data packet; an IP address—port number combination comparator that compares the IP address and the port number combination to one or more IP address—port number combinations previously stored in memory; and a notice signal generator that generates a notice signal when the IP address—port number combination comparator identifies more than a predetermined number of previously stored IP address—port number combinations that match the IP address and the port number combination, wherein the network interface transmits the notice signal to an Internet Service Provider (ISP) to identify the device, and wherein the network interface further transmits the portion of the predetermined file to be reproduced on the device to verify the communication session. The network system may further comprise a file list comparator that compares a current file list that corresponds to the received data packet to one or more stored file lists when the IP address—port number combination comparator does not identify a match for the IP address—port number combination. The network system may further comprise a time determiner that compares the time stamp with a predetermined time threshold.

The notice signal may comprise the portion of the predetermined file. The metadata may comprise a time stamp associated with the communication session. The predetermined file may comprise an audio file, a video file, a text file, a video game file, a movie file, a text file, or a data file.

The file list comparator may cause a start reporting record to be generated when the current file list is determined to match one or more stored file lists.

The time determiner may cause a stop reporting record to be generated when the time stamp is determined to exceed the predetermined time threshold.

According to a further aspect of the disclosure, a network system is provided that identifies a device participating in two or more communication sessions on a network where an IP address assigned to the device is subject to change, wherein the network system comprises: a network interface that receives a data packet from the device corresponding to a communication session; a packet parser that separates metadata from a header of the received data packet, the metadata comprising an IP address and a port number corresponding to the received data packet; an IP address—port number combination comparator that compares the IP address and the port number combination to one or more IP address—port number combinations previously stored in memory; and a notice signal generator that generates a notice signal when the IP address—port number combination comparator identifies more than a predetermined number of previously stored IP address—port number combinations that match the IP address and the port number combination, wherein the network interface transmits the notice signal to an ISP to identify the device.

The notice signal may comprise a portion of the communication session. The metadata may comprise a time stamp associated with the communication session. The communication session may include a portion of a predetermined file. The predetermined file may comprise an audio file, a video file, a text file, a video game file, a movie file, a text file, or a data file.

The network system may further comprise a file list comparator that compares a current file list that corresponds to the received data packet to one or more stored file lists when the IP address—port number combination comparator does not identify a match for the IP address—port number combination. The file list comparator may cause a start reporting record to be generated when the current file list is determined to match one or more stored file lists.

The network system may further comprise a time determiner that compares the time stamp with a predetermined time threshold. The time determiner may cause a stop reporting record to be generated when the time stamp is determined to exceed the predetermined time threshold.

According to a still further aspect of the disclosure, a network system is provided that identifies a device participating in two or more communication sessions on a network where an IP address assigned to the device is subject to change, wherein the network system comprises: a network interface that receives a data packet from the device corresponding to a communication session that includes a portion of a predetermined file; a packet parser that separates metadata from a header of the received data packet, the metadata comprising an IP address and a port number corresponding to the received data packet; an IP address—port number combination comparator that compares the IP address and the port number combination to one or more IP address—port number combinations previously stored in memory; and a file list comparator that compares a current file list that corresponds to the received data packet to one or more stored file lists when the IP address—port number combination comparator does not identify a match for the IP address—port number combination, wherein the file list comparator causes a start reporting record to be generated when the current file list is determined to match one or more stored file lists. The predetermined file may comprise an audio file, a video file, a text file, a video game file, a movie file, a text file, or a data file.

Additional features, advantages, and embodiments of the disclosure may be set forth or apparent from consideration of the detailed description, drawings and attachment. Moreover, it is to be understood that the foregoing summary of the disclosure and the following detailed description, drawings and attachment are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1A shows an example of a system for identifying a device on a network;

FIG. 1B shows an example of components that may be included in a server;

FIG. 2 shows an example of a process for detecting multiple communication sessions by the device in the network;

FIG. 3A shows an example of a notification process, according to principles of the disclosure;

FIG. 3B shows an example of a further notification process, according to principles of the disclosure;

FIG. 3C shows an example of a still further notification process, according to principles of the disclosure;

FIG. 4 shows an example of a redirect webpage, according to principles of the disclosure;

FIG. 5 shows an example of a process for determining whether an identified device has stopped using a particular IP address and port number combination and started using a new IP address and port number combination;

FIG. 6 shows another example of a process for determining whether a particular device has stopped using a particular IP address and port number combination and started using a new IP address and port number combination in carrying out communication sessions;

FIG. 7 shows an example of a process that includes a machine learning process to identify a device that may rotate its IP address;

FIG. 8 shows an example of a process that may be carried out to apply a machine learning algorithm to an input data set;

FIG. 9 shows an example of a process that may be carried out in sorting through and interpreting the results of a machine learning algorithm;

FIGS. 10 and 11 show an example of reconciliation screen that may be presented on a device; and

FIG. 12 shows an example of a process for carrying out a verification process.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

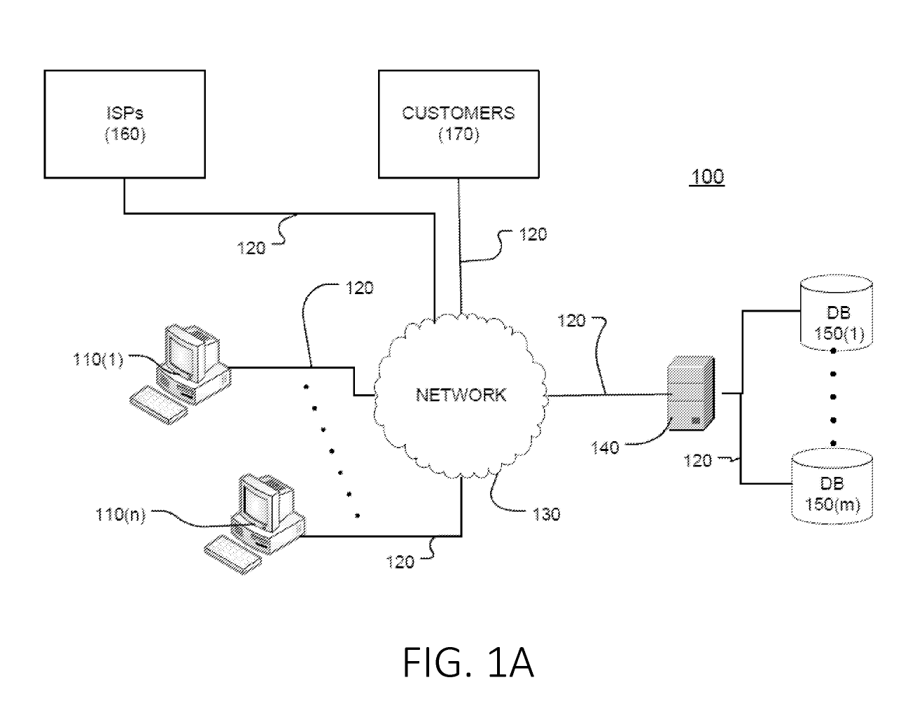

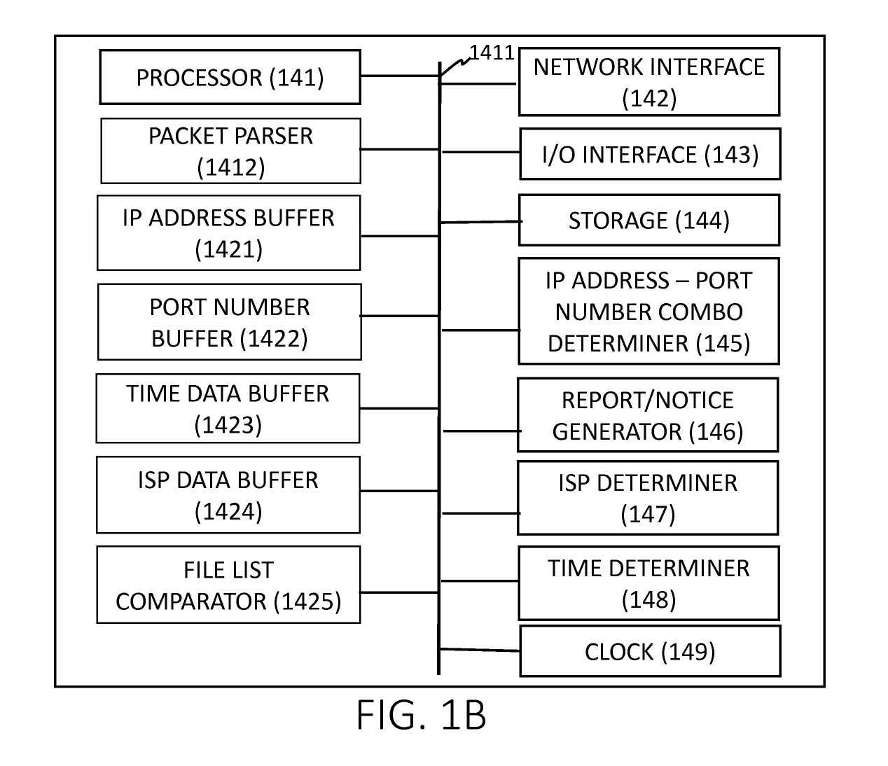

FIG. 1A shows an example of a system 100 for identifying a device 110 (e.g., any one of a plurality of devices 110(1) to 110(n) (individually or collectively referred to as “device 110”), where n is a positive, non-zero integer) communicating on a network 130. The system 100 includes a server 140, one or more databases 150(1) to 150(m) (referred to individually or collectively as “database 150,” where m is a positive, non-zero integer), one or more ISPs 160, and one or more customer computers 170. The server 140 and database(s) 150 may be connected to each other and/or the network 130 via one or more communication links 120. The device(s) 110, the ISP(s) 160, and the customer computer(s) 170 may be coupled to the network 130 via communication links 120. The customer computer 170 may include, for example, but is not limited to a computer of an individual, a privately owned entity, a corporation, a government agency (e.g., the Department of Justice), or the like. The ISP 160 may be provided with a unique login identification and password to access a virtual space allocated to the particular ISP 160 on the server 140 or database 150. Similarly, the customer computer 170 may be provided with a unique login identification and password to access a virtual space allocated to the particular customer 170 on the server 140 or database 150.

Each device 110 may be communicately coupled to the network 130 and may include a network interface (not shown). The server 140, databases 150, ISPs 160, and customers 170 may similarly include a network interface. The network 130 may use a transport layer protocol, such as Transmission Control Protocol (TCP) and/or User Datagram Protocol (UDP), together with a network layer protocol such as Internet Protocol (IP) to transport and manage communication of data packets across the network 130. The transport layer may specify a source and a destination port number in the headers of data packets. The port number may include a two-byte (or 16-bit) unsigned integer, ranging from 0 to 65535. Of the 65,535 port numbers, 1,024 port numbers are regarded as well known. For instance, port numbers 80 and 443 are generally associated with the Internet, with port number 80 being associated with the World Wide Web (“WWW”) and port number 443 being associated with the WWW using Secure Socket Layer (“SSL”), respectively.

The electronic mail system on the Internet is a good example of the use of port numbers in communications on the Internet. The mail system typically includes a mail server for sending and receiving email communications. The mail server typically provides two services, including a first service to transport email to and from other servers using the Simple Mail Transfer Protocol (SMTP), and a second service that uses either the Post Office Protocol (POP) or the Internet Message Access Protocol (IMAP) to retrieve email messages from the server. The SMTP service application usually listens on TCP port number 25 for incoming requests; and, the POP service listens on TCP port number 110. Both services may be running on the same host computer, in which case the port number distinguishes the service that was requested.

The network layer may include a four (4) byte IP address (IPv4) or a six (6) byte IP address (IPv6) that is assigned to each network interface card (not shown) on each device 110. This can be done, for example, automatically by the ISP 160 that services the device 110 by using network software such as DHCP, or manually at the device 110 by entering a static IP addresses into the device 110. The IP addresses may then be used to locate and connect to the devices 110 on the network 130.

During communication on the network 130, the device 110 may implement a binding process that associates the device's input/output channels by means of an Internet socket, which may include a type of file descriptor, with a transport protocol, a port number, and an IP address. The binding process may enable sending and receiving data by the device 110 over the network 130. The device's operating system networking software may be tasked with transmitting outgoing data from all application ports onto the network 130, and forwarding arriving network packets to processes by matching the IP addresses and port numbers parsed from headers of incoming data packets. A single process in the device 110 may bind to a specific IP address and port combination using the same transport protocol.

The IP address assigned to each device 110 serves as a unique identifier for a network interface (not shown) at the network layer. When the network interface is connected to the network 130, the IP address may be used to locate and establish a communication session with the associated device 110. The IP address may include a network prefix number, a host number, and a subnet number. The network prefix number may be provided to the device 110 by the associated ISP 160 that provides service to the device 110.

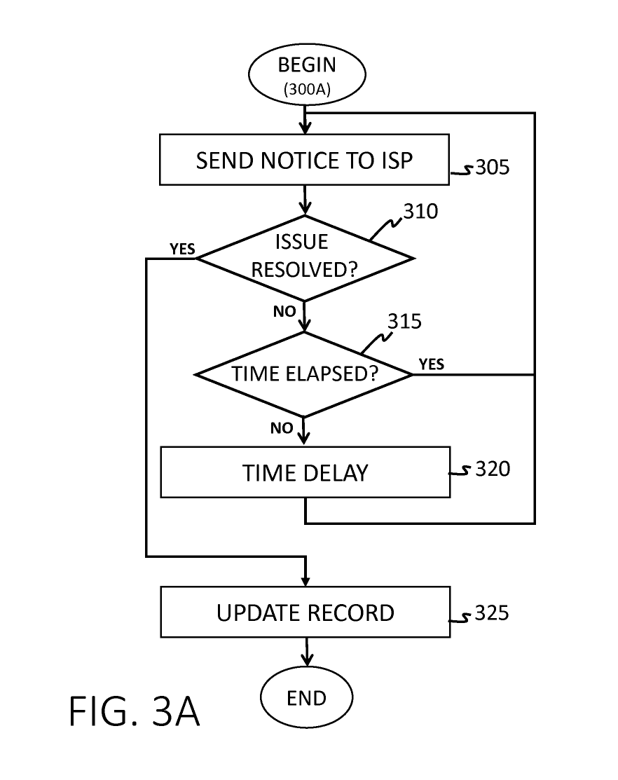

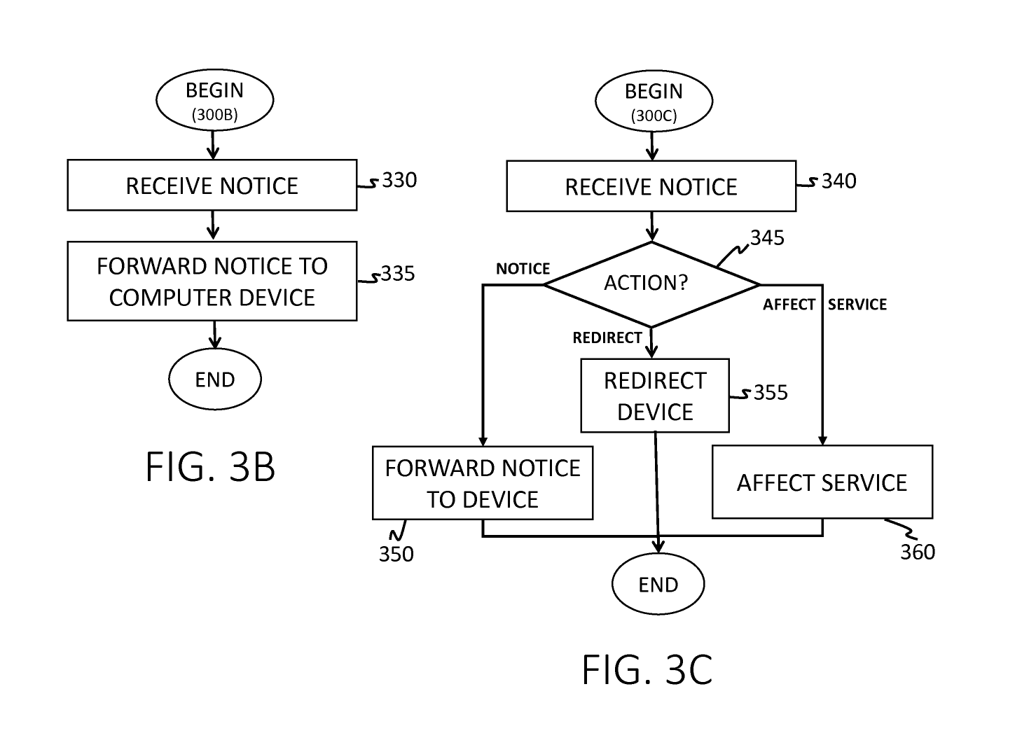

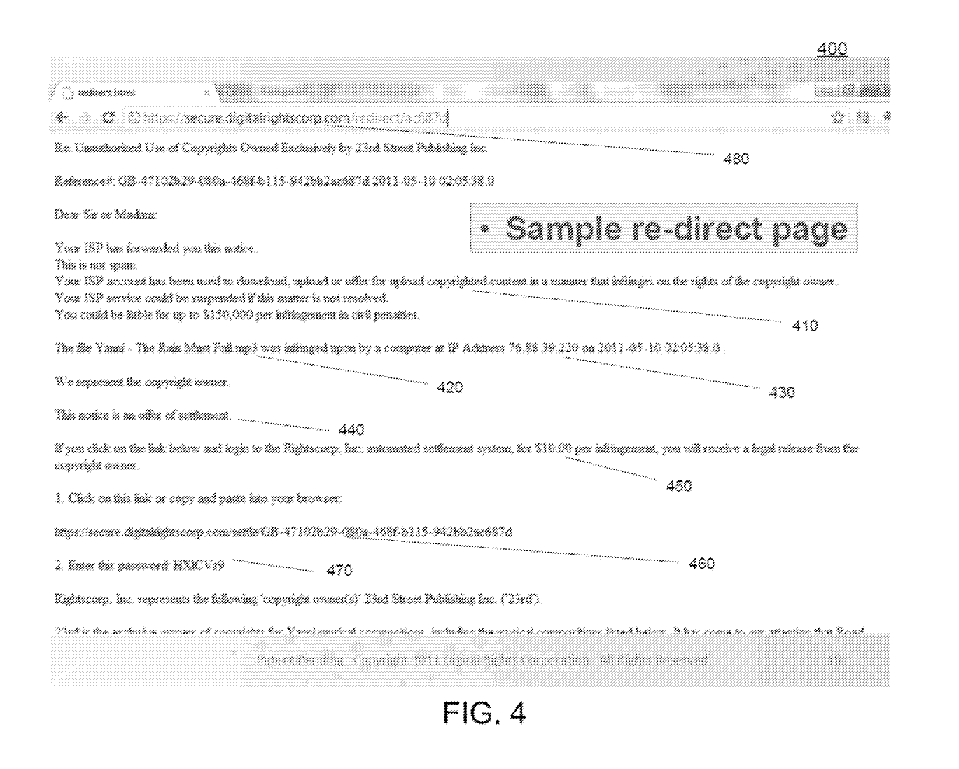

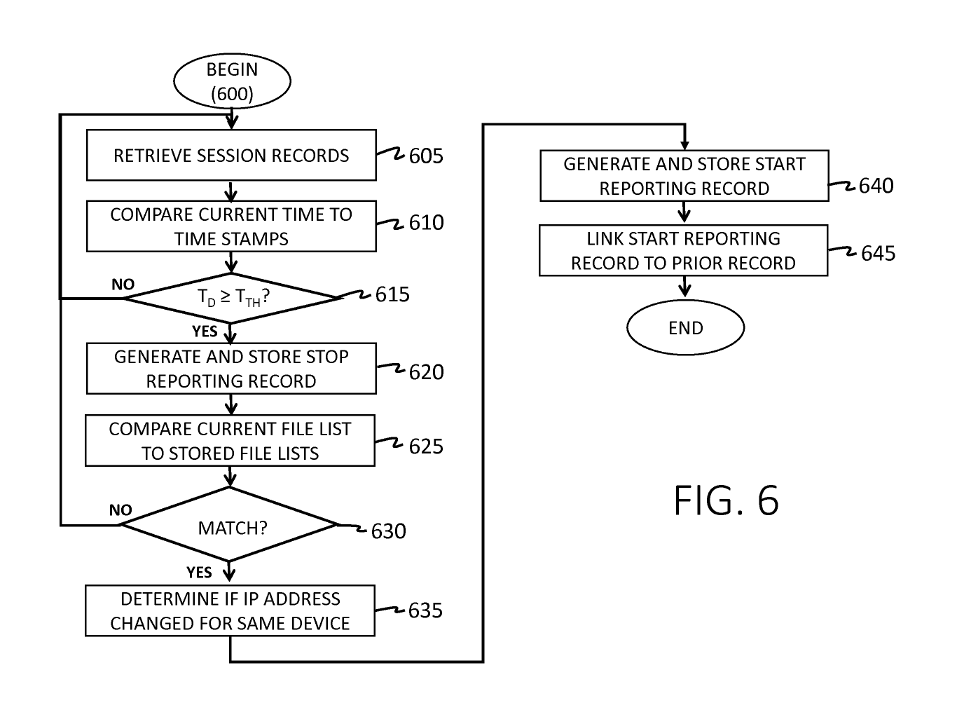

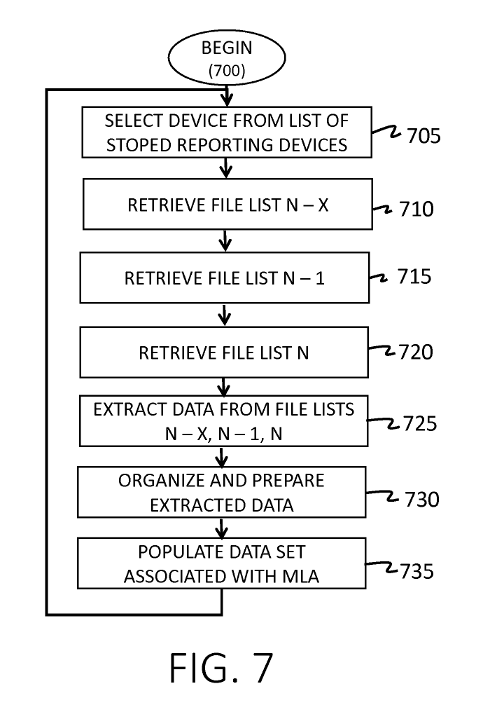

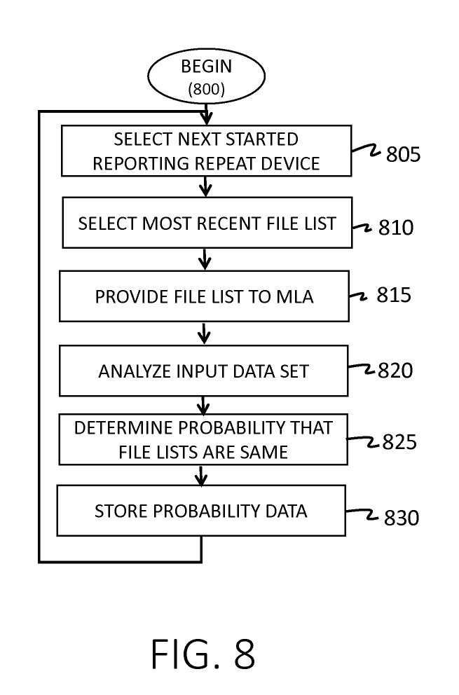

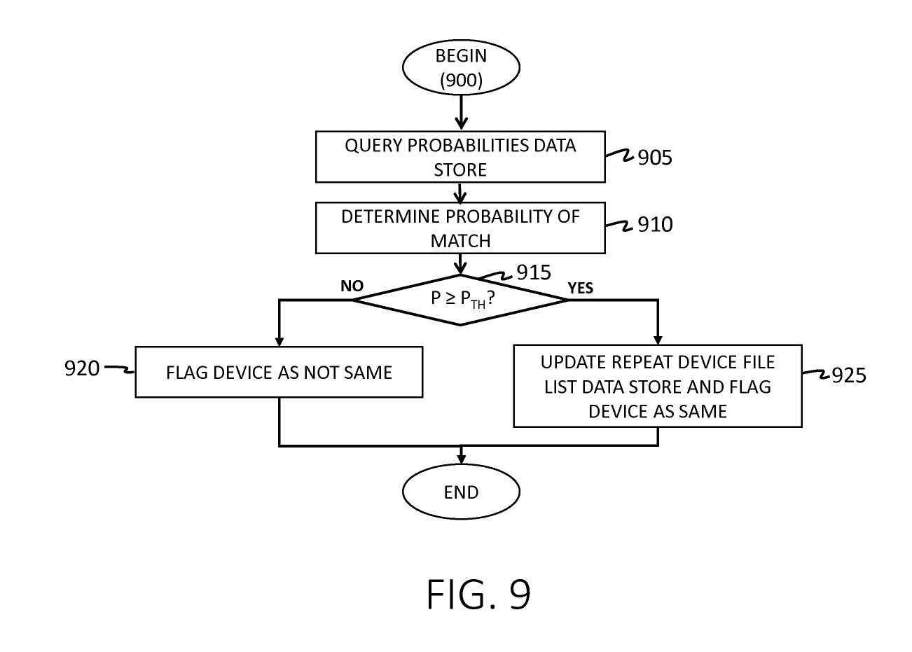

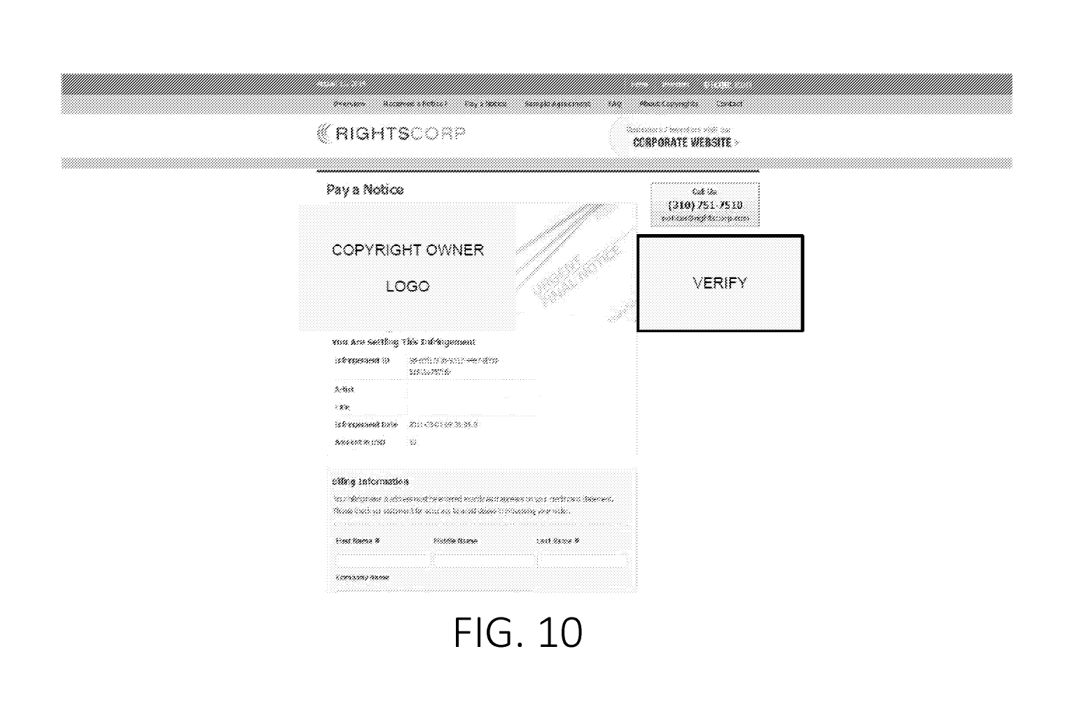

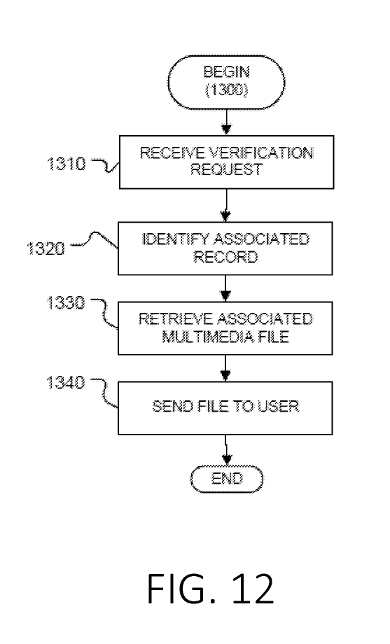

FIG. 1B shows an example of components that may be included in the server 140. The components may be implemented using hardware and/or software. As seen, the server 140 may include a processor 141, a packet parser 1412, a network interface 142, an IP address buffer 1421, a port number buffer 1422, a time data buffer 1423, an ISP data buffer 1424, a file list comparator 1425, an input/output (I/O) interface 143, a storage 144, an IP address—port number combination determiner 145, a report/notice generator 146, an ISP determiner 147, a time determiner 148, and a system clock 149, all of which may be connected to a bus 1411. The processor 141 may be configured to execute the processes described herein, including process 300A (shown in FIG. 3A), 300B (shown in FIG. 3B), 300C (shown in FIG. 3C), 500 (shown in FIG. 5), 600 (shown in FIG. 6), 700 (shown in FIG. 7), 800 (shown in FIG. 8), 900 (shown in FIG. 9) or 1300 (shown in FIG. 12).

The network interface 142 is configured to initiate, manage and terminate a communication session with one or more computers on the network 130, including the devices 110, databases 150, ISPs 160, or customers 170. The network interface 142 may also initiate, manage and termination communication sessions with other servers 140. The communication interface 142 may transmit and receive digital signals comprising data packets over a communication link 120 and network 130. The data packets may include a header and a payload, as is known in the art. The packet parser 1412 parses metadata from the headers of received IP data packets and provides metadata such as, for example, IP address data, port number data, time stamp data, and the like. The digital signal may be received from the device(s) 110 and the signal may include, for example, TCP/IP data packets that include headers with metadata.

The I/O interface 143 is configured to receive data signals and instruction signals via a user interface (not shown) and output data signals and instruction signals to the same or a different user interface (not shown). The user interface(s) may include a keyboard, keypad, a touchpad, a mouse, a touch-screen display, a display device, a speaker, a microphone, or the like.

The storage 144 may include a volatile memory, a non-volatile memory, a random access memory (RAM), a dynamic RAM (DRAM), a static RAM (SRAM), a read-only memory (ROM), a PROM, an EPROM, an EEPROM, or the like. The storage 142 may include a plurality of caches or registers, including, for example, an IP address register(s) (or cache(s)) that stores IP address data, a port number register(s) that stores port number data, a time data register(s) that stores time stamp data, an ISP data register(s) that stores an identification(s) for an ISP(s). The ISP identification may include an ISP IP address.

The IP address buffer 1421 may store the IP address data for a particular communication session conducted by a particular device 110. The IP address data may be received from the packet parser 1412 and buffered in the IP address buffer 1421. As noted previously, the packet parser 1412 may parse the header data from the data packets that are received from the particular device 110 during the communication session to identify the IP address used by the device 110.

The port number buffer 1422 may store the port number data that is parsed by the packet parser 1412 from the headers of the data packets received from the particular device 110.

The time data buffer 1423 may store the time stamp data that is parsed by the packet parser 1412 from the headers of the data packets received from the particular device 110. The time stamp data may include, for example, time data at which the particular communication session began with the particular device 110, the time data at which the particular communication session ended, the duration of the particular communication session, and the like.

The ISP data buffer 1424 may store the identification data for the ISP 160 that hosted or provided services to the particular device 110 during the particular communication session. The ISP data may include the IP address for the ISP 160.

The file list comparator 1425 compares a list of files on the particular device 110 from which the data packets are received for the particular communication session to one or more file lists in storage that are associated with previously identified and recorded communications sessions, as described in greater detail below. The communication sessions may include unauthorized communication sessions.

The IP address—port number combination determiner 145 may include a comparator that may compare the IP address and port number in the buffers 1421 and 1422 for the particular communication session, respectively, to one or more IP addresses—port number combinations retrieved from storage 144 or from a remote storage (e.g. database 150) to determine a match. The retrieved IP addresses—port number combinations may be stored in storage 144 during the comparison.

Alternatively, the server 140 may include executable code that may be executed by the processor 141 to compare the IP address and port number in the buffers 1421 and 1423, respectively, for the particular communication session to the one or more retrieved IP address—port number combinations stored in storage 144 or queried at the database 150 for prior communication sessions. In the latter regard, the packet parser 1412 may parse IP address data and port number data from data packets received from the device 110 via communication links 120 and network interface 142. The data parser 1412 may parse the metadata from the data packets in the received digital signal. The metadata may include the IP address, port number, time stamp, ISP address, and the like. The processor 141 may generate and cause a query to be sent to the database 150 to retrieve records that have the same IP address and port number combination, which may be stored in storage 144.

The ISP determiner 147 may include a comparator that may compare the ISP data in the ISP data buffer 1424 for the particular communication session to one or more ISP identifiers retrieved from storage 144 or a remote storage (e.g., database 150) to determine a match.

Alternatively, the server 140 may include executable code that may be executed by the processor 141 to compare the ISP data in the buffer 1424 for the particular communication session to the one or more ISP identifiers from previous communication sessions.

The time determiner 148 may include a comparator that may compare the time data in the time data buffer 1423 for the particular communication session to one or more time stamps retrieved from storage 144 or a remote storage (e.g., database 150) to determine a match.

Alternatively, the server 140 may include executable code that may be executed by the processor 141 to compare the time data in the buffer 1423 to the one or more retrieved time stamps.

The report/notice generator 146 may be configured to generate a notice signal and cause the notice signal to be transmitted to an ISP 160 via the network interface 142, communication link 120 and network 130. The report/notice generator 146 may be configured to receive an output from the IP address—port number combination determiner 145 and generate a device identification signal for the device 110, where two or more communication sessions were carried out on the same IP address and port number combination. The device identification signal may include the IP address and port number combination, a time stamp, and the like, which may be used by the ISP 160 servicing the device 110 to verify the identity of the device 110.

The clock 149 is a conventional system clock that may be used by the processor 141, as well as one or more of the components that are coupled to the bus 1411 in FIG. 1B.

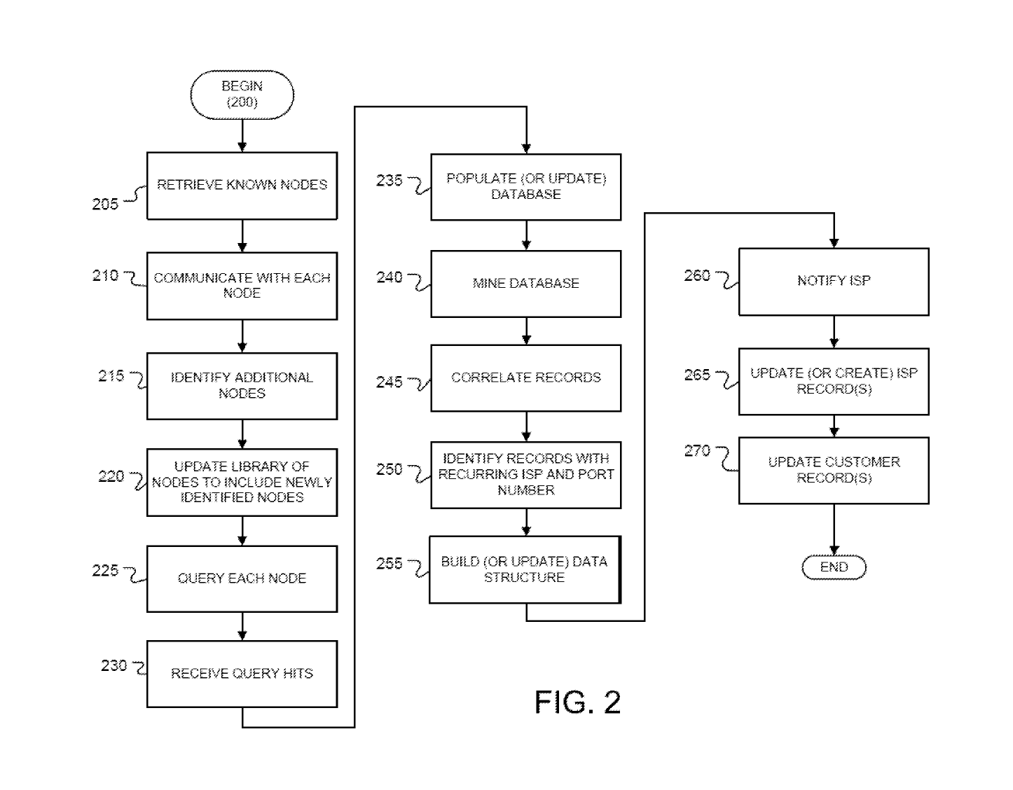

FIG. 2 shows an example of a process 200 for identifying a particular device 110 communicating on the network 130. The process 200 may be carried out by the server 140.

Referring to FIGS. 1A, 1B and 2, the process 200 begins at step 205 by retrieving all known devices 110 (or “nodes”) on the network 130 in order to generate a library of devices 110. A device 110 may include any device that is an endpoint (“node”) of data transmission or reception across the network 130. The device 110 may be associated with an IP address and a port number. The library of known devices 110 may be retrieved from a local storage (e.g., storage 144) or a remote storage (e.g., database 150). The library of known devices 110 may be retrieved from the network 130. At step 210, a communication signal may be sent to each of the devices 110 (or fewer than all of the devices 110) in the library of devices in an attempt to discover additional devices 110. This signal may comprise a query for additional devices 110.

In response to the query, a response signal may be received (e.g., at the server 140 via the network interface 142) comprising the results of the query from the devices 110 that were queried. In step 215, the response signal may be processed and a determination made regarding whether the response signal includes an identification of one or more additional devices 110. If one or more additional devices 110 are identified, the one or more additional devices 110 may be added to the library of known devices (nodes) in step 220 and stored in the local (or remote) storage, thereby providing the capability to update the library of known devices 110.

After updating the library of devices, step 225 provides that each of the devices 110 in the updated list of devices may be queried to determine if the devices include one or more predetermined files. Such a query may include a request to receive a copy of one or more predetermined files, or any portion thereof. The query of step 225 may include a keyword, a number, an alphanumeric character, or the like.

In step 230, one or more query hits may be received from the queried devices 110. A query hit may include a response to the query that indicates that the device 110 will provide a copy of the predetermined file(s). Such a response may thereby constitute a communication session (or act or event), which may be an unauthorized communication session. Each query hit may include metadata corresponding to the communication session. The metadata may include an IP address, a port number, a file name, a time stamp, a software version of the peer-to-peer software used to download (or upload) the predetermined file(s), an ISP identifier, or the like. The metadata may include infringement data. Then, at step 235 a database 150 may be populated with data associated with the received query hit including the metadata.

After the database 150 has been populated with the metadata, the database may be mined in step 240. For instance, each of the records in the database may be retrieved and analyzed or a query may be submitted to the database to return particular records containing metadata. At step 245, all of the records (or a portion of all records) may be correlated in order to cluster, or group together, records having a predetermined relationship. The predetermined relationship may be, for example, a same or substantially the same IP address and port number combination (also referred to herein as IP address-port number combination). As a result of the correlating process, it is possible to easily identify records that have the same, or substantially the same, predetermined relationship in step 250.

In order to facilitate efficient organization and maintenance of the clustered records, one or more data structures may be generated and populated with the identified records having the same, or substantially the same, IP address—port number combination at step 255. The data structure may be a table, an array, a list, a linked list, a tree structure, or the like. If a corresponding data structure already exists, then the data structure may be updated with any newly identified records or information.

At step 260, an ISP 160 may be notified when one or more communication sessions have been detected for a particular device 110 on the network 130 (shown in FIG. 1A). Such an ISP 106 may be notified when a single communication session by the device 110 has been detected. Alternatively, the method could be implemented in a manner that focuses on only notifying the ISP 160 when repeat communications sessions are detected for the same device 110. The repeat communication sessions may include repeat unauthorized communication sessions.

Repeat communication sessions may be detected by monitoring a predetermined threshold associated with the number of entries populating each generated data structure. For example, the method may provide that once a predetermined number (such as, for example, 5, 10, 20, or any positive number greater than 1) of data structure entries are identified that have substantially the same IP address—port number combination, a device 110 may be associated with the IP address and port number combination and the ISP 160 associated with the IP address may be notified of the one or more communication sessions carried out by the device 110 at the particular IP address and port number combination. The notification may include time data for each communication session, including, for example, the time at which the communication session began and terminated. The time data may include the duration of each communication session at the particular IP address and port number combination.

The notification may be in the form of a communication signal such as, for example, an email, a text signal, an instruction signal, a data signal, an audio signal, a video signal, or the like, and may include one or more of the IP address, the port number, and the time stamp(s). The notification may include updating a file, a data structure, a record, metadata, or the like, with at least a portion of the metadata associated with the communication session(s) by the same device 110, including one or more of the IP address, the port number, the file name, and the time stamp, which may be accessed by the ISP 160.

The ISP 160 may be provided with a dashboard that may be displayed on a display device (not shown) at the ISP 160. The dashboard may be populated with communication session data for the particular ISP 160 for one or more of the devices 110 that the ISP 160 services. The ISP communication session data may include a total number of communication sessions for a given time period (e.g., a second, a minute, an hour, a day, a week, a month, a year, a time range, a date range, or the like), the total number of unique IP address—port number combinations during the time period, the number of communication sessions associated with each unique IP address—port number combination, the metadata for each communication session, or the like.

The ISP communication session data may further include reconciliation data. The reconciliation data may include information regarding any reconciliation (e.g., settlement, payment, modification of service, suspension of service, termination of service, criminal activity report, or the like) for a particular communication session, whether the reconciliation was forwarded to the customer 170 (e.g., copyright owner, government agency, proxy, or someone authorized by the owner of the underlying content to settle the unauthorized communication session, or the like), the identity of the customer 170, the identity or a portion of the predetermined file that was communicated during the communication session, or the like.

After the ISP 160 has been notified in step 260, the record(s) (or profile) that is/are associated with the particular ISP may be updated with the entries of the associated data structure in step 265. If a record does not exist for the particular ISP, then a record may be created.

A customer notification including customer data may be communicated to the customer computer 170. Such customer data may be used to update customer records in step 270. The customer notification may be in the form of an electronic communication such as, for example, an instruction signal, an email, a text message, a data signal, an audio signal, a video signal, or the like, and may include the customer data. The customer data may include metadata for each ISP 160 and/or unique IP address and port number combinations, including, for example: an identification of the ISP 160, the number of unique IP address and port number combinations, the number of communication sessions corresponding to each unique IP address and port number combination, an identification (e.g., a names) of the predetermined files downloaded or uploaded during the communications sessions by each unique IP address and port number combination, the dates and times of each of the communication session associated with each IP address and port number combination, or the like. The customer notification data may further include historical data for each ISP 160, for each unique IP address and port number combination, for each predetermined file name, or the like.

The customer computer 170 may be provided with a dashboard that is populated with customer data. The dashboard may be displayed on a display device (not shown) of the customer computer 170. The dashboard may include a webpage accessed by the customer computer 170 on the server 140 via network 130. The customer data may further include, for example, a total number of communication sessions for a given time period (e.g., a second, a minute, an hour, a day, a week, a month, a year, a time range, a date range, or the like), the total number of unique IP address—port number combinations during the time period, the number of communication sessions corresponding to each unique IP address and port number combination, the metadata for each communication session, or the like.

The customer data may further include the customer reconciliation data. The reconciliation data may include the IP address and port number combination associated with the communication session(s), whether the IP address and port number is a repeat infringement offender, whether the ISP 160 has taken any action (such as sent a notice to the device 110, redirected the device's Internet access requests to a redirect webpage, disconnected the device 110 from the network 130, or the like), the nature of the type of action taken, or the like.

According to an aspect of the disclosure, a computer readable medium is provided containing a computer program, which when executed on, for example, the server 140, causes the process 200 in FIG. 2 to be executed. The computer program may be tangibly embodied in the computer readable medium, comprising one or more program instructions, code segments, or code sections for performing steps 205 through 270 when executed by the server 140.

FIG. 3A shows an example of a notification process 300A, according to principles of the disclosure. After a communication session (or act or event) has been identified and verified for a particular IP address and port number combination, thereby identifying the particular device 110 at the IP address at the time of the identified communication session (for example, by following one or more steps of the process 200, shown in FIG. 2), a notification may be sent to the ISP 160 that provides service to the particular device 110 in step 305. The notification may include an email, a text message, a data signal, an audio signal, a video signal, or the like, which includes the ISP address, the IP address, the port number, and/or a time stamp. The notification may include updating a file, a table, a record, or the like, with at least a portion of the metadata associated with the communication session, including the IP address, the port number, the file name, and/or the time stamp associated with the communication session. The metadata may be accessed by the ISP 160.

After the notification has been sent to the ISP 160 (step 305), a determination may be made as to whether a particular communication session (“issue”) was resolved in step 310. For instance, in step 310, a determination may be made whether an act of copyright infringement by the communication session was settled by an infringer, service has been modified or terminated to the particular device 110 corresponding to the communication session, or the like. If the issue is determined to have been resolved (YES at step 310), then reconciliation data (e.g., a settlement confirmation) may be sent to the ISP 160 and the associated records may be updated accordingly in step 325, otherwise (NO at step 310) a determination may be made as to whether a predetermined time has elapsed (e.g., 1 day, 5 days, 10 days, etc.) in step 315. The determination may be made by, for example, the time determiner 148, shown in FIG. 1B.

If it is determined that the predetermined time has elapsed (YES at step 315), then a subsequent notification may be sent to the ISP 160 in step 305, otherwise (NO at step 315) no action is taken for a time period indicated in step 320. After the expiration of the time period established in step 320, the process 300A may again determine whether the issue has been resolved in step 310. The time period (“delay”) may be substantially equal to, or less than, the predetermined time.

A computer readable medium may be provided containing a computer program, which when executed on, for example, the server 140, causes the process 300A in FIG. 3A to be carried out. The computer program may be tangibly embodied in the computer readable medium, comprising one or more program instructions, code segments, or code sections for performing steps 305 through 325 when executed by the server 140.

FIG. 3B shows an example of a further notification process 300B, according to principles of the disclosure. After a communication session has been identified and verified for a particular IP address and port number combination (for example, by following one or more steps of the process 200, shown in FIG. 2), the ISP 160 associated with the corresponding device 110 may receive a notification in step 330 from, for example, the server 140 over the network 130. After the ISP 160 receives the notification in step 330, the ISP 160 may forward a notice to the particular device 110 identified in the notification in step 330. The notice may include, e.g., an email, an instruction signal, a text message, a data signal, an audio signal, a video signal, or the like. The notice may also include an IP address, a port number, a file name downloaded or uploaded by the device 110, a software version of the peer-to-peer software used to download (or upload) the predetermined file on the device 110, historical information, an ISP identifier, a portion of the predetermined file communicated during the communication session by the device 110, and/or at least one time stamp associated with communication session.

FIG. 3C shows an example of a notification process 300C, according to principles of the disclosure. After a communication session has been identified and verified for a particular IP address and port number combination on the network 130 (for example, by following one or more steps of the process 200, shown in FIG. 2), the associated ISP 160 may receive a subsequent notification in step 340. The subsequent notification may include an instruction (or a suggestion) that the ISP 160 execute one or more of a plurality of actions. The ISP 160 may determine which action to execute in response to the received notification. At step 345, the executed actions may include, for example, sending a notice signal (NOTICE at step 345, then step 350), a redirect signal that redirects the device 110 to a redirect webpage (REDIRECT at step 345, then step 355), or affecting service to the device 110 (AFFECT SERVICE at step 345, then step 360). The notice signal may include, for example, an infringement notice, a copyright notice, a settlement offer, or the like. The redirect webpage may include a webpage on the server 140, or on a server (not shown) at the Department of Justice, or the like. The affecting service may include, for example, suspending, terminating, modifying, slowing, or otherwise affecting access to the network 130 by the identified device 110 via the ISP 160.

A computer readable medium may be provided containing a computer program, which when executed on, e.g., the ISP 160 and/or server 140, causes the processes 300B and/or 300C in FIGS. 3B and/or 3C, respectively, to be carried out. The computer program may be tangibly embodied in the computer readable medium, comprising one or more program instructions, code segments, or code sections for performing steps 330 through 335 and/or 340 through 360 when executed by, e.g., one or more computers, the ISP 160, server 140, and/or the like.

According to an aspect of the disclosure, in the system 100 (shown in FIG. 1A), a computer program (or software) may crawl the network 130 and communicate with devices 110(1) to 110(n) that may have predetermined files that the system 100 may want to monitor, such as, e.g., copies of copyrighted materials. For instance, the computer program running on the server 140 may cause the server 140 to establish a communication session with a device 110 over the network 130, and identify and record a communication session by the device 110, as well as metadata corresponding to the communication session. The computer program may retrieve metadata including, e.g., the file name, the IP address, the timestamp, and the port number from each device 110 that has a predetermined file to be monitored. The computer program may then mine the metadata and output an activity list that includes a list of devices 110 that were previously identified as carrying out communications sessions, as well as the number of communication sessions for each unique IP address-port number combination. For instance, in communicating with 2,289,948 devices 110, the ten most popular port numbers may be displayed in Table 1.

TABLE 1

| Port # | # of occurrences | Probability |
|---|---|---|
| 27016 | 661,009 | 28.87% |
| 6346 | 159,853 | 6.98% |
| 6348 | 12,552 | 0.55% |
| 63460 | 2,244 | 0.10% |
| 6349 | 1,737 | 0.08% |
| 6350 | 1,577 | 0.07% |
| 1 | 1,422 | 0.06% |
| 43795 | 1,178 | 0.05% |
| 17145 | 1,151 | 0.05% |
| 10800 | 1,080 | 0.05% |

In the example set forth in Table 1, where forty-three (43) IP addresses are identified with communication sessions with the same port number over a partially consecutive sequence of days, there is N % probability that these IP addresses are from the same device 110, where N is a real number between 0 and 100. N varies based on the port number. If the IP addresses are rotated between one communication session and the next, there is, for example, about a 2244/2,289,948 or about 0.1% chance that the same IP address 75.9.73.1 would land on port 63460 after the rotation. Therefore, there is a 99.9% chance that these communication sessions displayed in Table 2 are from the same device 110.

TABLE 2

| | | | | | | |
|---|---|---|---|---|---|---|
| 1 | GB-9fd5fbf1-a7f7-4e6c-b307- | lost in love | Air Supply-Lost In Love.mp3 | May 23, 2011 | 75.9.73.155 | 63460 |
| | fc7d7831e6cc | | | 12:24 PM | | |
| 2 | GB-b3273ba3-999b-4392-bb43- | making love out of | Air Supply-Making Love Out of | May 23, 2011 | 75.9.73.155 | 63460 |
| | a8cfd729fb04 | nothing at all | Nothing At All.mp3 | 12:24 PM | | |
| 3 | GB-bb6881c3-9629-440c-8d03- | two less lonely people | Air Supply-Two Less Lonely | May 23, 2011 | 75.9.73.155 | 63460 |
| | be087d8db717 | in the world | People In The World.mp3 | 12:24 PM | | |
| 4 | GB-4353c463-bfc7-45ba-b876- | young love | Air Supply-Young Love.mp3 | May 23, 2011 | 75.9.73.155 | 63460 |
| | e06a7c283698 | | | 12:24 PM | | |
| 5 | GB-e2db0c93-2345-4aaf-b2aa- | here i am | Air Supply-Here I Am.mp3 | May 23, 2011 | 75.9.73.155 | 63460 |
| | d0594f0f4f10 | | | 12:24 PM | | |
| 6 | GB-b4f3a7b1-4652-4c91-b5f9- | the power of love | Air Supply-The Power Of | May 23, 2011 | 75.9.73.155 | 63460 |
| | d94d94387726 | | Love.mp3 | 12:24 PM | | |
| 7 | GB-88ab0a85-b441-4a8f-8305- | lonely is the night | Air Supply-Lonely is the | May 23, 2011 | 75.9.73.155 | 63460 |
| | fa3f804763dc | | night.mp3 | 12:24 PM | | |
| 8 | GB-53fe2596-4e8c-46db-88f3- | every woman in the | Air Supply-Every Woman In the | May 25, 2011 | 75.9.73.155 | 63460 |
| | 370970f4bbce | world | World.mp3 | 12:57 PM | | |
| 9 | GB-2ae0a505-2642-422f-81b6- | goodbye | Air Supply-Goodbye.mp3 | May 25, 2011 | 75.9.73.155 | 63460 |
| | f25f9232bd69 | | | 12:57 PM | | |
| 10 | GB-907674ea-bf60-4ce8-80ef- | just as i am | Air Supply-Just As I Am.mp3 | May 25, 2011 | 75.9.73.155 | 63460 |
| | 40e7fa13e084 | | | 12:57 PM | | |
| 11 | GB-0c29344c-41d9-4f57-9b5c- | even the nights are | Air Supply-Even The Nights Are | May 25, 2011 | 75.9.73.155 | 63460 |
| | a0a8155c9c12 | better | Better.mp3 | 12:57 PM | | |
| 12 | GB-4cee17eb-5b28-434d-814b- | the one that you love | Air Supply-The One That You | May 25, 2011 | 75.9.73.155 | 63460 |
| | 3c1dfebd5be4 | | Love.mp3 | 12:57 PM | | |
| 13 | GB-4aefed32-3ba6-4204-9aaf- | all out of love | Air Supply-All Out of Love.mp3 | May 25, 2011 | 75.9.73.155 | 63460 |
| | fdac4f7b9328 | | | 12:57 PM | | |
| 14 | GB-70abcbfb-1459-45dc-83e5- | sweet dreams | Air Supply-Sweet Dreams.mp3 | May 25, 2011 | 75.9.73.155 | 63460 |
| | 2686c0c7165c | | | 12:57 PM | | |
| 15 | GB-0cb4fa57-dbf1-4c0b-9579- | lost in love | Air Supply-Lost In Love.mp3 | May 25, 2011 | 75.9.73.155 | 63460 |
| | 3a250cfe50ec | | | 12:57 PM | | |
| 16 | GB-c4563c81-8e52-4f88-ab6b- | making love out of | Air Supply-Making Love Out of | May 25, 2011 | 75.9.73.155 | 63460 |
| | 73a3a86a34de | nothing at all | Nothing At All.mp3 | 12:57 PM | | |
| 17 | GB-1633f76d-6bc7-44b5-a526- | two less lonely people | Air Supply-Two Less Lonely | May 25, 2011 | 75.9.73.155 | 63460 |
| | 21f564dfaefc | in the world | People In The World.mp3 | 12:57 PM | | |
| 18 | GB-87ff6ee5-9e5a-484f-8e60- | young love | Air Supply-Young Love.mp3 | May 25, 2011 | 75.9.73.155 | 63460 |
| | 8a68a277c8bd | | | 12:57 PM | | |
| 19 | GB-ff8b0517-2480-4f45-8420- | here i am | Air Supply-Here I Am.mp3 | May 25, 2011 | 75.9.73.155 | 63460 |
| | 97c28235eab0 | | | 12:57 PM | | |
| 20 | GB-ea7ab0e5-264f-4eeb-8071- | the power of love | Air Supply-The Power Of | May 25, 2011 | 75.9.73.155 | 63460 |
| | 63d2f0da9f04 | | Love.mp3 | 12:57 PM | | |
| 21 | GB-c782705c-0b9b-4138-881f- | lonely is the night | Air Supply-Lonely is the | May 25, 2011 | 75.9.73.155 | 63460 |
| | 4f359e4255d3 | | night.mp3 | 12:57 PM | | |
| 22 | GB-5d2d1c06-cfd4-4bac-9f09- | every woman in the | Air Supply-Every Woman In the | Jun. 12, 2011 | 75.9.73.155 | 63460 |
| | 0e428b6ca49f | world | World.mp3 | 9:07 AM | | |
| 23 | GB-60899d15-cd3d-40dc-a33f- | goodbye | Air Supply-Goodbye.mp3 | Jun. 12, 2011 | 75.9.73.155 | 63460 |
| | d7846f1ec384 | | | 9:07 AM | | |
| 24 | GB-f6af7108-5920-4105-a0c2- | just as i am | Air Supply-Just As I Am.mp3 | Jun. 12, 2011 | 75.9.73.155 | 63460 |
| | 2f2f178ff61e | | | 9:07 AM | | |
| 25 | GB-412b5ec7-ecc9-435d-a68d- | even the nights are | Air Supply-Even The Nights Are | Jun. 12, 2011 | 75.9.73.155 | 63460 |
| | 756113fa16c8 | better | Better.mp3 | 9:07 AM | | |
| 26 | GB-60548f2d-a4a4-4e79-982a- | the one that you love | Air Supply-The One That You | Jun. 12, 2011 | 75.9.73.155 | 63460 |
| | 336ab429a120 | | Love.mp3 | 9:07 AM | | |
| 27 | GB-7cddd798-9563-474d-af15- | all out of love | Air Supply-All Out of Love.mp3 | Jun. 12, 2011 | 75.9.73.155 | 63460 |
| | fcda779127fe | | | 9:07 AM | | |
| 28 | GB-beb9929d-ce41-4341-b112- | sweet dreams | Air Supply-Sweet Dreams.mp3 | Jun. 12, 2011 | 75.9.73.155 | 63460 |
| | 7df150b8349e | | | 9:07 AM | | |
| 29 | GB-173bba2b-8dbc-4961-9eb4- | lost in love | Air Supply-Lost In Love.mp3 | Jun. 12, 2011 | 75.9.73.155 | 63460 |
| | 17f5fb20f318 | | | 9:07 AM | | |
| 30 | GB-d6c24553-ec2a-458e-9b24- | making love out of | Air Supply-Making Love Out of | Jun. 12, 2011 | 75.9.73.155 | 63460 |
| | 38f0d5381cd4 | nothing at all | Nothing At All.mp3 | 9:07 AM | | |
| 31 | GB-3c6733b8-c6ed-494a-8d88- | two less lonely people | Air Supply-Two Less Lonely | Jun. 12, 2011 | 75.9.73.155 | 63460 |
| | 3062100c9e04 | in the world | People In The World.mp3 | 9:07 AM | | |
| 32 | GB-899d05dc-1aa0-40cb-869c- | young love | Air Supply-Young Love.mp3 | Jun. 12, 2011 | 75.9.73.155 | 63460 |
| | 34dd141293bd | | | 9:07 AM | | |
| 33 | GB-468c93a8-8d57-40b2-85e2- | here i am | Air Supply-Here I Am.mp3 | Jun. 12, 2011 | 75.9.73.155 | 63460 |
| | de90cf3ca0e5 | | | 9:07 AM | | |
| 34 | GB-070748b4-87bc-41e3-8767- | the power of love | Air Supply-The Power Of | Jun. 12, 2011 | 75.9.73.155 | 63460 |
| | 5268bbd675ba | | Love.mp3 | 9:07 AM | | |
| 35 | GB-9d384b80-f6f6-40d7-9cfd- | lonely is the night | Air Supply-Lonely is the | Jun. 12, 2011 | 75.9.73.155 | 63460 |
| | a204af21e9f7 | | night.mp3 | 9:07 AM | | |
| 36 | GB-1baea34d-74eb-4916-8119- | every woman in the | Air Supply-Every Woman In the | Jun. 23, 2011 | 75.9.73.155 | 63460 |
| | 57a059c68ebd | world | World.mp3 | 1:29 AM | | |
| 37 | GB-7dc63e89-34c1-409c-b402- | goodbye | Air Supply-Goodbye.mp3 | Jun. 23, 2011 | 75.9.73.155 | 63460 |
| | 869cf10938f8 | | | 1:29 AM | | |
| 38 | GB-b526ade9-248a-4d4c-91fc- | just as i am | Air Supply-Just As I Am.mp3 | Jun. 23, 2011 | 75.9.73.155 | 63460 |
| | 932f25c6b1d8 | | | 1:29 AM | | |
| 39 | GB-f343cabe-6184-4476-af28- | even the nights are | Air Supply-Even The Nights Are | Jun. 23, 2011 | 75.9.73.155 | 63460 |
| | 7400b3c5e9ac | better | Better.mp3 | 1:29 AM | | |
| 40 | GB-bcf01917-5760-440e-bf79- | the one that you love | Air Supply-The One That You | Jun. 23, 2011 | 75.9.73.155 | 63460 |
| | ad47031b5a60 | | Love.mp3 | 1:29 AM | | |
| 41 | GB-5a349997-cd70-43e7-a632- | all out of love | Air Supply-All Out of Love.mp3 | Jun. 23, 2011 | 75.9.73.155 | 63460 |
| | 1525b79142f3 | | | 1:29 AM | | |
| 42 | GB-c26d4f12-7f0a-4197-a1bb- | sweet dreams | Air Supply-Sweet Dreams.mp3 | Jun. 23, 2011 | 75.9.73.155 | 63460 |
| | 0c67f36aa535 | | | 1:29 AM | | |
| 43 | GB-39675430-27fc-4ca7-9c1f- | lost in love | Air Supply-Lost In Love.mp3 | Jun. 23, 2011 | 75.9.73.155 | 63460 |
| | f22078098417 | | | 1:29 AM | | |

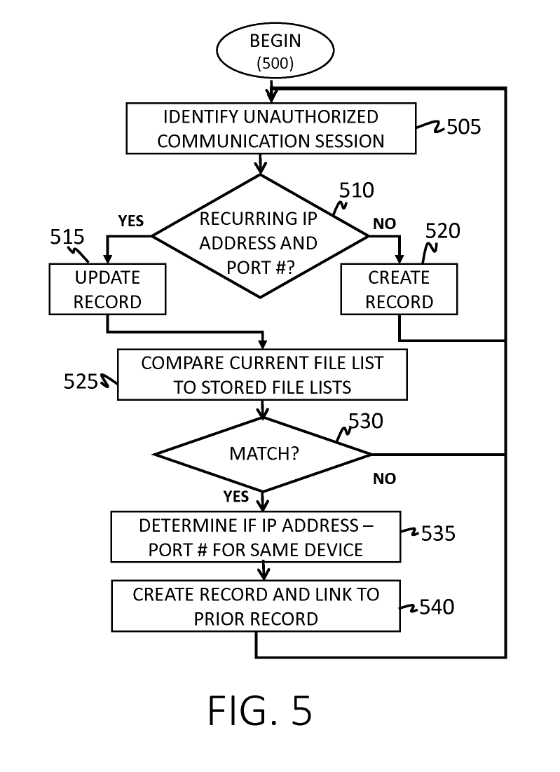

FIG. 4 shows an example of a redirect webpage 400 that may be generated and displayed on the device 110, or that may be generated by the server 140 and accessed by the device 110 via the network 130. The redirect webpage 400 may be displayed on the device 110 where the ISP 160 (shown in FIG. 1A) determines at step 345 (shown in FIG. 3C) that the request for Internet access by the identified device 110 should be redirected. The ISP 160 may determine to redirect a request for Internet access for a plurality of different reasons. The ISP 160 may determine to redirect a request for Internet access because the ISP 160 has received a notification indicating that a particular device 110 associated with the ISP has been identified as carrying out a communication session such as, for example, an act of copyright infringement.

The ISP 160 may determine to redirect a request for Internet access because the ISP 160 has received a subsequent notice instructing (or requesting or suggesting) the ISP 160 to redirect any requests for Internet access received by the device 110 that has been identified as carrying out a communications session.

The ISP 160 may determine to redirect a request for Internet access because the ISP has independently determined that the device 110 is associated with a communication session.

One of ordinary skill in the art will appreciate that the disclosure is not limited to the foregoing examples. As a result, it will be readily apparent to one of ordinary skill in the art that an ISP 160 may determine to redirect a request for Internet access for any reason that falls within the spirit and scope of the disclosure.

Redirect webpage 400 may include general information 410 associated with redirect webpage and a communication session, such as, for example, an act of copyright infringement. The redirect webpage 400 may include at least a portion of the metadata corresponding to the communication session. For example, the redirect webpage 400 may include information identifying the predetermined file 420 (for example, copyrighted material or work). The redirect webpage 400 may include information identifying the particular device 110 and/or a user associated with the device 430. Information that identifies the device 110 and/or the user may include an IP address, a port number, a timestamp, a user ID, or the like. The redirect webpage 400 may include a reconciliation offer such as, for example, a notice of a settlement offer to resolve the communication session 440. The redirect webpage 400 may provide notice of a predetermined payment amount 450, that if satisfied, would settle and resolve the communication session. The predetermined payment amount may include, e.g., a flat fee (e.g., $10, $20, $100, or any other amount deemed to be acceptable by, e.g., the copyright owner).

The redirect webpage 400 is not limited to including the portions of the metadata provided above. Instead, the redirect webpage 400 may be configured to include any portion of the metadata within the redirect webpage 400. As a result, the redirect webpage 400 may also include one or more of a software version of the peer-to-peer software used to download (or upload) the predetermined file(s), historical information associated with the device 110 that carried out the communication session, and/or an ISP identifier.

The redirect webpage 400 may also include a link 460 associated with a reconciliation (e.g., payment) website to resolve a communication session. The redirect webpage 400 may be configured to receive selection of the link from the device 110. In response, the device 110 may be provided access to a settlement resolution module. The settlement resolution module may be configured to accept payment from the device 110 (for example, as an automated payment, or the like) for an amount equal to the predetermined payment amount. The settlement resolution module (not shown) may be included in the report/notice generator 146 (shown in FIG. 1B), or the report/notice generator 146 may be the settlement resolution module. Access to a record on (or via) the settlement resolution module may require the use of a password 470. The password 470 may be provided by the redirect webpage 400 to the user device 110.

The redirect webpage 400 may be generated and maintained by the server 140 (shown in FIG. 1A). After an ISP 160 (shown in FIG. 1A) determines to redirect a request for Internet content by a device 110 at step 340, the ISP 160 may redirect the request for Internet content to the redirect webpage 400 that is associated with the particular IP address—port number combination for the particular device 110. The ISP 160 may continue to indefinitely redirect the particular device 110 to the redirect webpage 400 on the server 140 until the communication session(s) has been resolved and the ISP 160 has received a resolution confirmation notice for the identified communication session(s) at step 340 (shown in FIG. 3C). Further, until the confirmation notice is received from the server 140, the device 110 may be prevented from accessing any other site on the network 30, except for the redirect webpage 400.

The identified device 110 may be redirected to one or more other websites, such as, for example, the Department of Justice website, which includes webpages related to civil and/or criminal penalties for acts of copyright infringement.

Access on the network 130 that is provided to a device 110 may be temporarily suspended, permanently terminated, slowed, modified, or otherwise affected by the ISP 160 at step 360 (shown in FIG. 3C). In the event that the ISP 160 suspends access to the network 130 by the device 110, the service may remain suspended until the associated communication session(s) has been resolved and the ISP 160 has received a resolution confirmation notice from, for example, the server 140 at step 340.

Further, the redirect webpage 400 may be generated and maintained by the ISP 160 or a customer 170 (shown in FIG. 1A).

FIGS. 1-4 have generally described examples of the disclosure directed to identifying a particular device 110 that has carried out one or more communication sessions on the network 130 based on an IP address—port number combinations. Such examples are particularly useful during a window of time when an IP address assigned to a device 110 remains static. However, the IP address for a given device 110 may change with a new communication session where dynamic IP addressing is applied, as is frequently the case. ISPs 160 may frequently rotate IP addresses for devices 110(1) to 110(n) to accommodate a greater number of devices on their services. A device 110 may implement IP address rotation, which refers to the dynamic changing of a device's IP address, and thereby bypass a network blocking mechanism to avoid detection for communication sessions (such as, for example, unauthorized file sharing), or otherwise provide a device 110 with the opportunity to remain anonymous while the device 110 is accessing the network 130. IP address rotation may be performed by changing one or more numbers in a device's IP address. IP address rotation may be achieved manually or automatically, e.g., at fixed time intervals, random time intervals, etc.

According to a further aspect of the disclosure, a method is provided that may accurately identify a device 110 that has changed its IP address. The method may include one or more aspects of the port matching method described herein.

FIG. 5 shows an example of a process 500 for determining whether a particular device 110 has stopped using a particular IP address and port number combination and started using a new IP address and port number combination.

Referring to FIGS. 1A and 5, the system 100 (shown in FIG. 1A) determines whether a particular device 110 has carried out a communication session at 505. The current IP address and port number combination corresponding to the current communication session is compared to previously recorded IP address and port number combinations for prior communication sessions, and a determination is made whether the current IP address and port number combination are recurring at 510. The step 510 may be carried out by the IP address—port number combination determiner 145, for example (shown in FIG. 1B). If a determination is made that the current IP address and port number combination have not been previously identified (NO at 510), then a new record may be created and stored at 520, which may include the current IP address, port number, time stamp, identification of the predetermined file that was communicated during the communication session, a list of files on the device, and the like. If a determination is made that the IP address and port number combination have been previously identified with a communication session (YES at 510), then the record corresponding to the IP address and port number combination may be updated and stored in, for example, the server 140 or database 150. The stored record may include the IP address, port number, time stamp, identification of the predetermined file that was communicated during the communication session, a list of files on the device, and the like. The list of files may include, for example, the predetermined file(s), audio files, video files, game files, data files, multimedia files, or the like, that reside on the device 110. The list of files may include files that may be available for download, distribution, copying, or upload to other devices 110 on the network 130.

The list of files on the device 110 corresponding to the current IP address and port number combination may be compared to previously stored lists of files at 525. If a determination is made that the list of files on the device 110 corresponding to the current IP address and port number combination substantially matches a previously stored list of files (YES at 530), then a determination may be made that the current IP address and port number combination correspond to the same device 110 that was associated with the IP address and port number combination corresponding to the previously stored list of files at 535. If a determination is made that the list of files does not match any previously stored lists of files (NO at 530), then the process 500 may return to identify the next communication session at 505 and repeat. The step 530 may be carried out by the file list comparator 1425 (shown in FIG. 1B).

After a determination is made that the current IP address and port number combination are for the same device 110 as a previously stored different IP address and port number combination at 535, the record(s) for the current IP address and port number combination may be linked to the record(s) of the previously stored different IP address and port number combination at 540. The process 500 may end after the records are linked, or the process 500 may repeat.

FIG. 6 shows an example of a process 600 for determining whether a particular device 110 has stopped using a particular IP address and port number combination and started using a new IP address and port number combination in carrying out communication sessions.

Referring to FIGS. 1A and 6, records of prior communication sessions may be retrieved and/or queried at 605. The records may be retrieved from storage in, for example, the server 140 or database 150. For each IP address port number combination, the time stamp for the most recent communication session may be compared to the current time at 610. If a determination is made that the difference T_{D} between the current time and the time stamp for the most recent communication session exceeds a predetermined time threshold T_{TH} (YES at 615), then a determination may be made that the particular device 110 has stopped carrying out communication sessions on the particular IP address—port number combination, otherwise the process may return to retrieve another record(s) and repeat (NO at 615). The predetermined time threshold T_{TH} may be set to, for example, 3 hours, 6 hours, 12 hours, 1 day, 2 days, 5 days, 10 days, 30 days, 3 months, 6 months, or any other time period that may indicate that the device 110 has stopped carrying out communication sessions at a particular IP address and port number combination.

After the determination is made that the particular device 110 has stopped carrying out communication sessions on the particular IP address and port number combination (YES at 615), a stop reporting record may be generated and stored at 620 on the server 140 or database 150. The stop reporting record(s) may be linked to and associated with the stored records for the particular IP address and port number combination. The stopped reporting data store may maintain a data structure that stores metadata, including computer identifiers for previously identified IP address—port number combinations for which a communication session has not been reported within the predetermined time threshold T_{TH}. A communication session may be reported, for example, when a device 110 adds a predetermined file (e.g., copyrighted content) to the device's shared folder, thereby making the predetermined file available to other devices 110 on the network 130.

A determination may be made whether a device 110 stopped communication sessions associated with a unique IP address—port number combination by consulting the metadata stored on the server 140 or database 150 and the stopped reporting data store. The device 110 may be determined to have stopped communication sessions if, for example, the device 110 has not added predetermined file(s) to the device's shared folder within predetermined time threshold T_{TH}. Such a device 110 may be referred to herein as a stopped reporting device 110.

A stopped reporting device 110 may stop communications sessions associated with a unique IP address—port number combination because the device's IP address has dynamically changed, thereby resulting in a different IP address—port number combination being associated with the device 110.

After the stop reporting record is generated and recorded at 620, a determination may be made whether a new, or previously unidentified, device 110 has started communication sessions associated with a unique IP address—port number combination at 625. In this regard, the metadata for the newly identified IP address—port number combination may be compared at 625. For instance, a list of files on the device 110 associated with the newly identified IP address—port number combination (e.g., the list of files in the stop reporting record on server 140 or database 150) may be compared to previously stored lists of files associated with previously identified IP address—port number combinations. If it is determined that the current list of files is substantially the same as a previously stored list of files that corresponds to a different IP address—port number combination (YES at 630), then a determination may be made that the new IP address—port number combination corresponds to the same device 110 as that of the previously identified IP address—port number combination at 635. The step 630 may be carried out by the file list comparator 1425 (shown in FIG. 1B).

After the determination is made that the particular device 110 has started carrying out communication sessions on the new IP address—port number combination at 635, a start reporting record may be generated and stored at 640 on the server 140 or database 150. The start reporting record(s) may be linked to and associated with the stored records for the prior IP address—port number combination associated with the same device 110 at 640. The start reporting data store may maintain a data structure that stores metadata, including computer identifiers for previously identified IP address—port number combinations for which a communication session has not been reported within predetermined time threshold T_{TH}. A communication session may be reported, for example, when a device 110 adds a predetermined file to the device's shared folder, thereby making the predetermined file available to other devices 110 on the network 130.

The process 600 may determine whether a new, or previously unidentified, device 110 has started communications sessions associated with a unique IP address—port number combination by consulting stored records of prior communication sessions and the started reporting data store on the server 140 or database 150. A determination may be made that a same device 110 has started communication sessions using a new, or previously unidentified IP address—port number combination. Such a repeat offender or infringer may be referred to herein as a started reporting repeat device.

It is noted that the list of files accessed in step 625 may be stored in a list data store in the server 140 or database 150. The list data store may be organized in a manner that distinguishes lists of shared folder contents of different types of devices 110. For example, there may be a portion of the list data store designated to store shared folder content lists associated with stopped reporting repeat devices and a portion of the data store designated to store shared folder content lists associated with started reporting repeat devices. The file list data store may maintain a log of the contents of a particular shared folder during a particular time period. The time period may be measured in seconds, minutes, hours, days, weeks, etc.

The process 600 may determine the precise contents of a device's 110 shared folder on any particular day. For example, Table 3 illustrates an example of the contents of a shared folder as it existed on May 27, 2011 on the particular device 110.

TABLE 3

| | | | | | |
|---|---|---|---|---|---|
| 32-20 blues | Robert Johnson - 32-20 Blues.mp3 | 2788044 | 5/24/11 4:35 AM | 98.149.93.203 | 30366 |
| come on in my | Robert Johnson - Come On In My Kitchen | 2747663 | 5/24/11 4:35 AM | 98.149.93.203 | 30366 |
| kitchen | (1936).mp3 | | | | |
| love in vain | robert johnson - love in vain blues.mp3 | 2427214 | 5/24/11 4:35 AM | 98.149.93.203 | 30366 |
| terraplane blues | Robert johnson - Terraplane Blues..mp3 | 3574061 | 5/24/11 4:35 AM | 98.149.93.203 | 30366 |
| walking blues | Robert Johnson - Walking Blues.mp3 | 2420736 | 5/24/11 4:35 AM | 98.149.93.203 | 30366 |
| black dog | Led Zeppelin - Black Dog.mp3 | 4721266 | 5/27/11 7:55 AM | 98.149.93.203 | 30366 |
| good times bad | Led Zeppelin - Good Times Bad | 2659142 | 5/27/11 7:55 AM | 98.149.93.203 | 30366 |
| times | Times.mp3 | | | | |
| rock and roll | Led Zeppelin - Rock And Roll.mp3 | 3534262 | 5/27/11 7:55 AM | 98.149.93.203 | 30366 |
| stairway to | led zeppelin - stairway to heaven.mp3 | 7714143 | 5/27/11 7:55 AM | 98.149.93.203 | 30366 |
| heaven | | | | | |
| whole lotta love | led zepplin - led zeppelin ii - whole lotta | 5349002 | 5/27/11 7:55 AM | 98.149.93.203 | 30366 |
| | love.mp3 | | | | |

Table 3 shows the various types of data that may be associated with the contents of a device's shared folder that may be maintained in the file list data store on the server 140 (or database 150). The file list data store may include, e.g., the name of the predetermined file, the title of the predetermined file, the title of the content in the predetermined file, the artist of the content, the date the content was added to the shared folder on the device 110, the IP address of the device 110 that acquired the content, the port number of the device 110 that acquired the content, or the like. In the example in the table displayed above, the IP address—port number combination identifier of the device 110 associated with this particular shared folder is, e.g., IP address 98.149.93.203 and port number 30366.

Similarly, a subsequent inquiry into the contents of file list data store may yield a different file list. For instance, Table 4 displays an example of the contents of a shared folder on Jun. 24, 2011, as shown below for a device 110 with an IP address—port number combination of, e.g., IP address 98.149.93.42, port 30366:

TABLE 4

| | | | | | |
|---|---|---|---|---|---|
| black dog | Led Zeppelin - Black Dog.mp3 | 4721266 | 6/14/11 8:54 AM | 98.149.93.42 | 30366 |
| good times bad | Led Zeppelin - Good Times Bad | 2659142 | 6/14/11 8:54 AM | 98.149.93.42 | 30366 |
| times | Times.mp3 | | | | |
| rock and roll | Led Zeppelin - Rock And Roll.mp3 | 3534262 | 6/14/11 8:54 AM | 98.149.93.42 | 30366 |
| stairway to | led zeppelin - stairway to heaven.mp3 | 7714143 | 6/14/11 8:54 AM | 98.149.93.42 | 30366 |
| heaven | | | | | |
| whole lotta love | led zepplin - led zeppelin ii - whole lotta | 5349002 | 6/14/11 8:54 AM | 98.149.93.42 | 30366 |
| | love.mp3 | | | | |
| black dog | Led Zeppelin - Black Dog.mp3 | 4721266 | 6/23/11 11:26 AM | 98.149.93.42 | 30366 |
| good times bad | Led Zeppelin - Good Times Bad | 2659142 | 6/23/11 11:26 AM | 98.149.93.42 | 30366 |
| times | Times.mp3 | | | | |
| rock and roll | Led Zeppelin - Rock And Roll.mp3 | 3534262 | 6/23/11 11:26 AM | 98.149.93.42 | 30366 |
| stairway to | led zeppelin - stairway to heaven.mp3 | 7714143 | 6/23/11 11:26 AM | 98.149.93.42 | 30366 |
| heaven | | | | | |
| whole lotta love | led zepplin - led zeppelin ii - whole lotta | 5349002 | 6/23/11 11:26 AM | 98.149.93.42 | 30366 |
| | love.mp3 | | | | |
| 32-20 blues | Robert Johnson - 32-20 Blues.mp3 | 2788044 | 6/24/11 5:36 AM | 98.149.93.42 | 30366 |
| come on in my | Robert Johnson - Come On In My Kitchen | 2747663 | 6/24/11 5:36 AM | 98.149.93.42 | 30366 |
| kitchen | (1936).mp3 | | | | |
| love in vain | robert johnson - love in vain blues.mp3 | 2427214 | 6/24/11 5:36 AM | 98.149.93.42 | 30366 |
| terraplane blues | Robert johnson - Terraplane Blues..mp3 | 3574061 | 6/24/11 5:36 AM | 98.149.93.42 | 30366 |
| walking blues | Robert Johnson - Walking Blues.mp3 | 2420736 | 6/24/11 5:36 AM | 98.149.93.42 | 30366 |

The system 100 (shown in FIG. 1A) may therefore query the file list data store in order to obtain one or more file lists representing the contents of a device's shared folder. For example, a query may request a list of the contents of a device' shared folder for a particular day. The query may alternatively request a list of the contents of a device's shared folder as it existed on each individual day in a given month. In addition, the query may request two different lists representing the shared folder of two different devices 110. The two different devices 110 may be a stopped reporting repeat device and a started reporting repeat device. System 100 may obtain the lists described above by submitting a query that includes an identifier such as an IP address—port number combination.

Referring to step 625 in FIG. 6, the system 100 may query the stopped reporting data store on the server 140 or database 150 in order to determine a list of stopped reporting repeat devices. The system 100 may also query the started reporting data store in order to determine a list of started reporting repeat devices. Utilizing the data retrieved from the stopped reporting data store and the started reporting data store, the system 100 may query the file list data store(s) in order to retrieve the shared folder contents associated with each of the results returned from stopped reporting data store and started reporting data store.

The results returned from the query directed to the file list data stores may lead to the generation of one or more data structures. The first data structure may include a list of stopped reporting repeat (infringer) devices that may be associated with a list representative of the contents of the stopped reporting repeat (infringer) device's shared folder during a predetermined time period. The second data structure may include a list of started reporting repeat (infringer) devices that may be associated with a list representative of the contents of the started reporting repeat (infringer) device's shared folder during a predetermined time period.

The system 100 may proceed at 625 (in FIG. 6) to compare each stopped reporting repeat device's shared folder content list in the first data structure with each shared folder content list associated with a started reporting repeat device in the second data structure. If a substantially equivalent file list is detected, it may be determined that the stopped reporting repeat device and the started reporting repeat device are one and the same. If a less than exact match occurs, it may be concluded that the two repeat devices are not using the same device or a more detailed forensic analysis of data associated with each device may be performed as described herein below.

While the process described above may compare the contents of a device's shared folder in order to determine if two different IP address—port number combinations belong to the same device 110, it should be readily understood that the present disclosure is not so limited. For instance, in view of the present disclosure, it will be understood by one of ordinary skill in the art that any data that is associated with a device could be used in order to determine if two different IP address—port number combinations actually belong to the same device 110. For example, process 600 could compare metadata, names of the software used to share the predetermined file content, version number of the software used to share the predetermined file content, and/or transmission packet information in order to provide additional credibility to the determination that two different IP address—port number combinations identify the same device 110.

The process 600 provides a solution to the problem of devices that may attempt to avoid detection by rotating their IP address by comparing data sets as described herein. However, other aspects of the disclosure may provide for a more detailed forensic analysis of data associated with a given device 110.

The system 100 may perform a forensic process that includes a deeper forensic analysis of data associated with a device 110 by applying one or more existing machine learning algorithms, such as, e.g., but not limited to, a Bayesian Network Classifier.

The forensic process may include teaching the algorithm (e.g., Bayesian Network Classifier) with at least a portion of a known data set. For example, in accordance with one aspect of the disclosure, one may input a portion of gathered data that is known to identify, e.g., one or more particular stopped reporting repeat devices. This teaching data may include, e.g., a stopped reporting repeat device's metadata, including the IP address-port number combination, names of the software used to share the predetermined file content, version number of the software used to share the predetermined file content, transmission packet information, or any other data that may be associated with the description of a stopped reporting repeat device. After being taught with this training data, a machine learning algorithm may be endowed with a knowledge base that the machine learning algorithm can consult in order to make accurate predictions regarding future input data sets associated with a started reporting repeat infringer with a certain degree of probability.

The forensic process may then apply the trained machine learning algorithm to an input data set that may be associated with a started reporting repeat device. For example, a data set associated with a started reporting repeat device may be fed into the machine language algorithm. The machine learning algorithm may receive the input data set associated with a started reporting repeat device and determine a probability that, based at least in part on the trained data set associated with one or more stopped reporting repeat devices, the input data set falls within a particular category.

The forensic process may then sort through and interpret the results of the machine learning algorithm. The results, or output of the machine learning algorithm may include, e.g., a probability that an input data set falls within one of a plurality of categories. In other words, an output may be provided that indicates, e.g., the likelihood that the stopped reporting repeat device and the started reporting repeat device are using the same device 110.

FIG. 7 shows an example of a process 700 that includes a machine learning process to identify a device 110 that may rotate its IP address to, for example, avoid detection while participating in communication sessions. The process of teaching a machine learning algorithm may include, e.g., populating a data set associated with the machine algorithm.

Referring to FIGS. 1A and 7, the process 700 may include a step of teaching a machine learning algorithm with at least a portion of a known data set, which may be employed by the system 100 (shown in FIG. 1A). At 705, the process may select a stopped reporting repeat device 110 from a list of stopped reporting repeat devices 110. The stopped reporting repeat device may be selected, e.g., from the first data structure created in process 600 (shown in FIG. 6).

At 710, 715, and 720, a training input data set may be selected that may be used to train the machine learning algorithm. The training input data may be, e.g., a subset of the total number of shared folder file lists (hereinafter “file lists”) associated with a particular stopped reporting repeat device 110. One aspect of the present disclosure provides that the training input may be, e.g., 10% of the total number of file lists associated with a particular stopped reporting repeat device 110. The training input data may also be, e.g., selected from the most recently obtained file lists associated with a stopped reporting repeat device. Selecting the most recent file lists may be advantageous because it is likely that the contents of the file list associated with a stopped reporting repeat device 110 will be substantially equivalent to the file list of a started reporting repeat device at, or near, the time of an IP address rotation.

In accordance with an aspect of the disclosure, the system 100 (shown in FIG. 1A) may, e.g., maintain file lists for a stopped reporting repeat devices for N=90 days. During this time period a file list may be saved, e.g., once per day for 90 days. In accordance with this example, the most recent 10% of the stopped reporting repeat device's file list may be, e.g., a file list saved on day 90 (e.g., 3/31), a file list saved on day 89 (e.g., 3/30), a file list recorded on day 88 (e.g., 3/29), . . . and the file list stored on day 82 (e.g., 3/22) (including all file lists stored on days between day 82 and day 88).

At 725, the files lists depicted at 710, 715, and 720, may be input into a tokenizer (not shown). The tokenizer may be located in, for example, the server 140 (shown in FIG. 1A). The tokenizer may be a conventional tokenizer as is known in the art and may function to extract all necessary data from the file lists in order to create an adequate input data set to train the machine learning algorithm. Such a tokenizer may parse the files lists depicted at 710, 715, 720, to extract, e.g., file names, artist names, IP address, port number, or any other metadata that is associated with the file list and determined to facilitate training of the machine learning algorithm.

At 730, the output of the tokenizer may be organized and prepared to be used to populate a data set at 735 which may be associated with the machine learning algorithm (MLA). In accordance with one aspect of the disclosure, the output of the tokenizer at 730 may be, e.g., a bag of words and the data set at 735 may be, e.g., a Bayesian Dataset. However, the present disclosure is not so limited. For instance, in view of the present disclosure, it will be understood by one of ordinary skill in the art that the output of the tokenizer may be organized such that it could teach any data set associated with any machine learning algorithm.

After the output of the tokenizer has been organized at 730 and used to populate the data set at 735, the process may traverse back to 705 and repeat. This process 700 may continue to repeat in the manner described above until, e.g., each entry residing within the first data structure created in process 600 (shown in FIG. 6) has been processed in accordance with the process 700.

FIG. 8 shows an example of a process 800 that may be carried out by the system 100 (shown in FIG. 1A) to apply a machine learning algorithm to an input data set. After the process 800 begins, at 805, a started reporting repeat device may be selected. The started reporting repeat (infringer) device may be, e.g., associated with a new, or previously unidentified, IP address—port number combination. The started reporting repeat device may be selected, e.g., from the second data structure created in the process 600 (shown in FIG. 6).

At 810, the most recent file list associated with a started reporting repeat device may be selected and used to feed the machine learning algorithm at 815. Feeding the machine learning algorithm may be achieved by, e.g., passing the most recent file list associated with a started reporting repeat device to the machine learning algorithm as an input data set. At 820, a machine learning algorithm may be provided with the most recent file list associated with a started reporting repeat device as an input. The machine learning algorithm may then analyze the input data set in accordance with an associated trained data set, which may be stored in the server 140. The trained data set may be the same, or similar to, e.g., the data set trained in the process 700 (shown in FIG. 7).

At least one aspect of the present disclosure provides that the machine learning algorithm may be based at least in part on, e.g., a Bayesian Network Classification approach that may be fully automated. However, it is noted that the present disclosure is not so limited. For instance, in view of the present disclosure, it will be understood by one of ordinary skill in the art that any machine learning algorithm may be used in order to analyze a trained data set. Furthermore, while one or more aspects of the present disclosure may eliminate the need for human interaction in the process of analyzing input data sets in accordance with a trained data set, other aspects of the disclosure may invite a collaborative approach between a human and a machine when analyzing an input data set in accordance with the disclosure.

At 825, the process may provide the results of the execution of the machine learning algorithm at 820 after receiving the input data set described at 815. The results may be determined by, e.g., the machine language algorithm calculating the probability that the input data set at 815 representing the file list associated with a started reporting repeat device is substantially equivalent to the file list associated with a stopped reporting repeat (infringer) device that was input into the data set. The results at 825 may be expressed in the form of, e.g., a probability. This probability may then be stored in a data structure within a probabilities data store (not shown) at 830, which may be stored in the database(s) 150 or server 140 (shown in FIG. 1A). The step 825 may be carried out by the file list comparator 1425 (shown in FIG. 1B).

After the output of the results of the machine learning algorithm are stored in a data structure within the probabilities data store at 830, the process 800, may traverse back to 805 and repeat for the same ISP 160. This process 800 may continue to repeat in the manner described above until, e.g., each entry of the second data structure created in the process 600 (shown in FIG. 6) has been processed in accordance with the process 800.

FIG. 9 shows an example of a process 900 that may be carried out by the system 100 (shown in FIG. 1A) in sorting through and interpreting the results of the machine learning algorithm that were processed and stored in probabilities data store. After the process 900 begins, at 905 the system 100 (shown in FIG. 1A) may query the probabilities data store in order to retrieve the results of the machine learning algorithm that were stored in the probabilities data store. At 910, the system 100 may determine if there is greater than, e.g., a 99% probability (or any predetermined threshold probability) of a match between the file list associated with a stopped reporting repeat infringer device and the file list associated with a started reporting repeat infringer device. If at 915 it is determined that probability P is not greater than a predetermined threshold probability P_{TH} (e.g., P_{TH}=99% probability) of a match between the file list associated with the stopped reporting repeat device and file list associated with a started reporting repeat device (NO at 915), then the system 100 may record an indication (e.g., a flag) at 920 that the started reporting repeat device is not the same device as the stopped reporting repeat device.

If, instead, at 915 it is determined that there is a greater than P_{TH} (e.g., 99% probability) of a match between the file list associated with a stopped reporting repeat device and the file list associated with a started reporting repeat device, then the system 100 may update the repeat device file list data store in order to reflect that the stopped reporting repeat device and the started reporting repeat device are forensically determined to be the same device.

According to an aspect of the disclosure, a computer readable medium is provided containing a computer program, which when executed on, e.g., the server 140, causes the processes 500, 600, 700, 800, and 900 (shown in FIGS. 5-9, respectively) to be executed. The computer program may be tangibly embodied in the computer readable medium, comprising one or more program instructions, code segments, or code sections for performing the processes 500—900 when executed by, e.g., the server 140.

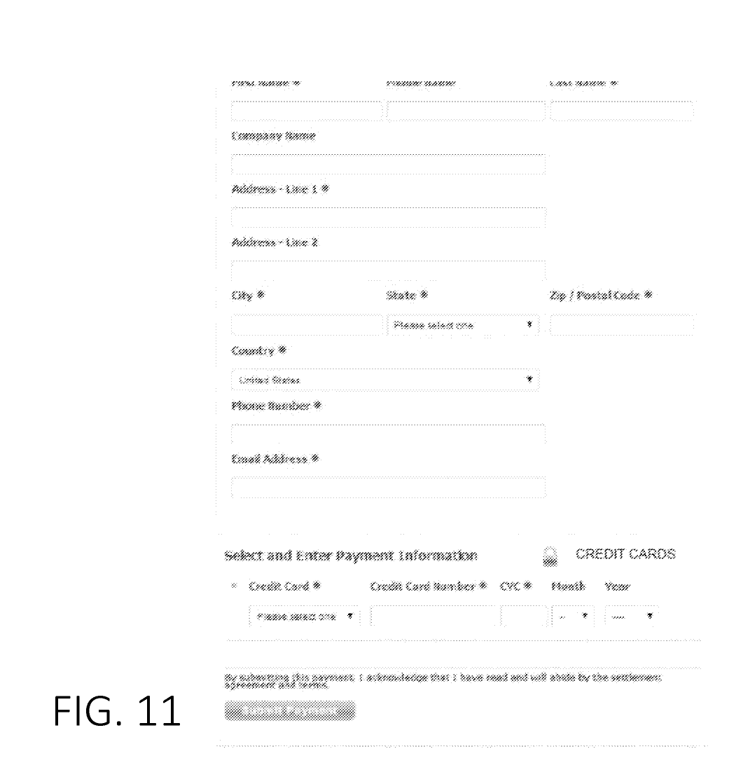

FIGS. 10 and 11 show an example of a reconciliation screen that may be presented on the display (not shown) of a device 110 (shown in FIG. 1A). The reconciliation screen may include reconciliation data such as, e.g., a pay notice, which may include the following fields, e.g., a copyright owner logo field, an infringement ID, an artist field, a title field, an infringement date field, an amount in USD field, a billing information field, a contact field, a verify field, and the like. As seen in FIG. 11, the reconciliation screen may include a first name field, a middle name field, a last name field, a company name field, address fields, a phone number field, an email address field, a payment selection field, and the like.

FIG. 12 shows an example of a process 1300 for carrying out a verification process according to the principles of the disclosure. Referring to FIGS. 10 and 12, should a user wish to verify that a communication session was captured and documented for the device's Internet connection, the user may select the verification field in FIG. 10 on the user's device 110, which may include a link that establishes communication to the server 140 (shown in FIG. 1A). Upon selection/actuation of the verification field on the device 110, a signal may be sent to the server 140, which may receive a verification request at 1310. Upon receiving the verification request, the server 140 may identify the particular record associated with the IP address—port number combination at 1320, and retrieve the associated predetermined file (or a portion thereof) from the record at 1330. The server 140 may then send the predetermined file (or portion thereof) to the device 110 at 1340. Accordingly, a user may select the verify field on his/her device 110 and reproduce the predetermined file (or portion thereof). For instance, after selecting the verify field, the device 110 may play a music file, a movie file, a video game file, an audio book file, or any portion thereof. This may allow the user of the device 110 to review the evidence that may be used against him/her to prove the communication session.

The disclosure described herein may therefore provide a method of forensically determining if two unique IP address—port number combinations are actually associated with the same computer. The application of principles of the disclosure set forth herein provides a solution to the problem of repeat infringers avoiding detection by rotating their IP address. The forensic determinations set forth herein may help to establish an evidentiary trail that may be used to obtain a subpoena in order to obtain the computer records belonging to a repeat infringer.

A “computer” and/or a “device” as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, a smart phone, a smart television, a smart appliance, or the like, or an array of processors, microprocessors, central processing units, general purpose computers, super computers, personal computers, laptop computers, palmtop computers, notebook computers, desktop computers, workstation computers, servers, smart phones, smart televisions, smart appliances, or the like.

A “server,” as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database,” as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link,” as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, and the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a broadband area network (BAN), a cellular network, a Peer-to-Peer (“P2P”) network (e.g., BitTorrent, the Internet, or the like, or any combination of the foregoing, any of which may be configured to communicate data via a wireless and/or a wired communication medium. These networks may run a variety of protocols not limited to TCP/IP, IRC or HTTP.

The terms “including,” “comprising” and variations thereof, as used in this disclosure, mean “including, but not limited to,” unless expressly specified otherwise.

The terms “a,” “an,” and “the,” as used in this disclosure, means “one or more,” unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “communication session,” as used in this disclosure, means a communication session between at least two computers (e.g., at least two devices, or at least a device and a server, or the like) in which a predetermined file (or a portion thereof) is made available for copying, distribution, reproduction, downloading, uploading, modification or use, or in which the predetermined file (or a portion thereof) is copied, distributed, reproduced, downloaded, uploaded, modified, or used. The “communication session” may include an unauthorized communication session that is carried out without authorization of the owner, rightful custodian, exclusive licensee, or the like, of the predetermined file, including any content therein, such as, for example, an act of copyright infringement.

A “predetermined file,” as used in this disclosure, means any file, data, data structure, or information that could be copied, distributed, reproduced, downloaded, uploaded, modified, or used by a device 110. The predetermined file may include, for example, a text file, an audio file, a video file, a multimedia file, a data file, or the like. The predetermined file may include a copyrighted material or work (or a portion thereof), a sound track, a music video, a video, a movie, a video game, a sound recording, a video recording, a computer file, a computer program, an audio book, or the like. The predetermined file may be identified and/or provided by, for example, the customer computer 170 (shown in FIG. 1A), who may be the owner, rightful custodian, exclusive licensee, or the like, of the predetermined file, including any content therein.

A “computer-readable medium,” as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read. The computer-readable medium may include a “Cloud,” which includes a distribution of files across multiple (e.g., thousands of) memory caches on multiple (e.g., thousands of) computers.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications, or modifications of the disclosure.

What is claimed is:

1. A network system that identifies a device participating in two or more communication sessions on a network where an IP address assigned to the device is subject to change, the network system comprising:
a network interface that receives a data packet from the device corresponding to a communication session that includes a portion of a predetermined file;
a packet parser that separates metadata from a header of the received data packet, the metadata comprising an IP address and a port number corresponding to the received data packet;
an IP address—port number combination comparator that compares the IP address and the port number combination to one or more IP address—port number combinations previously stored in memory; and
a notice signal generator that generates a notice signal when the IP address—port number combination comparator identifies more than a predetermined number of previously stored IP address—port number combinations that match the IP address and the port number combination,
wherein the network interface transmits the notice signal to an Internet Service Provider to identify the device, and
wherein the network interface further transmits the portion of the predetermined file to be reproduced on the device to verify the communication session.

2. The network system of claim 1, wherein the notice signal comprises the portion of the predetermined file.

3. The network system of claim 1, wherein the metadata comprises a time stamp associated with the communication session.

4. The network system of claim 1, wherein the predetermined file comprises an audio file, a video file, a text file, a video game file, a movie file, a text file, or a data file.

5. The network system of claim 1, the network system further comprising:
a file list comparator that compares a current file list that corresponds to the received data packet to one or more stored file lists when the IP address—port number combination comparator does not identify a match for the IP address—port number combination.

6. The network system of claim 5, wherein the file list comparator causes a start reporting record to be generated when the current file list is determined to match one or more stored file lists.

7. The network system of claim 3, the network system further comprising:
a time determiner that compares the time stamp with a predetermined time threshold.

8. The network system of claim 7, wherein the time determiner causes a stop reporting record to be generated when the time stamp is determined to exceed the predetermined time threshold.

9. A network system that identifies a device participating in two or more unauthorized communication sessions on a network where an IP address assigned to the device is subject to change, the network system comprising:
a network interface that receives a data packet from the device corresponding to an unauthorized communication session;
a packet parser that separates metadata from a header of the received data packet, the metadata comprising an IP address and a port number corresponding to the received data packet;
an IP address—port number combination comparator that compares the IP address and the port number combination to one or more IP address—port number combinations previously stored in memory; and
a notice signal generator that generates a notice signal when the IP address—port number combination comparator identifies more than a predetermined number of previously stored IP address—port number combinations that match the IP address and the port number combination,
wherein the network interface transmits the notice signal to an Internet Service Provider to identify the device.

10. The network system of claim 9, wherein the notice signal comprises a portion of the unauthorized communication session.

11. The network system of claim 9, wherein the metadata comprises a time stamp associated with the unauthorized communication session.

12. The network system of claim 9, wherein the metadata comprises a time stamp associated with the unauthorized communication session.

13. The network system of claim 9, wherein the unauthorized communication session includes a portion of a predetermined file.

14. The network system of claim 13, wherein the predetermined file comprises an audio file, a video file, a text file, a video game file, a movie file, a text file, or a data file.

15. The network system of claim 9, the network system further comprising:
a file list comparator that compares a current file list that corresponds to the received data packet to one or more stored file lists when the IP address—port number combination comparator does not identify a match for the IP address—port number combination.

16. The network system of 15, wherein the file list comparator causes a start reporting record to be generated when the current file list is determined to match one or more stored file lists.

17. The network system of claim 12, the network system further comprising:
a time determiner that compares the time stamp with a predetermined time threshold.

18. The network system of claim 17, wherein the time determiner causes a stop reporting record to be generated when the time stamp is determined to exceed the predetermined time threshold.

19. A network system that identifies a device participating in two or more unauthorized communication sessions on a network where an IP address assigned to the device is subject to change, the network system comprising:
a network interface that receives a data packet from the device corresponding to an unauthorized communication session that includes a portion of a predetermined file;
a packet parser that separates metadata from a header of the received data packet, the metadata comprising an IP address and a port number corresponding to the received data packet;
an IP address—port number combination comparator that compares the IP address and the port number combination to one or more IP address—port number combinations previously stored in memory; and
a file list comparator that compares a current file list that corresponds to the received data packet to one or more stored file lists when the IP address—port number combination comparator does not identify a match for the IP address—port number combination,
wherein the file list comparator causes a start reporting record to be generated when the current file list is determined to match one or more stored file lists.

20. The network system of claim 13, wherein the predetermined file comprises an audio file, a video file, a text file, a video game file, a movie file, a text file, or a data file.
